(19) United States
(12) Patent Application Publication
(10) Pub. No.: US 2025/0071021 A1
(43) Pub. Date: Feb. 27, 2025

(54) CONFIGURING COMPONENTS OF A SOFTWARE-DEFINED NETWORK TO AUTOMATICALLY DEPLOY AND MONITOR LOGICAL EDGE ROUTERS FOR USERS

(71) Applicant: VMware, LLC, Palo Alto, CA (US)

(72) Inventors: Minjal Agarwal, Santa Clara, CA (US); Abhishek Goliya, Pune (IN); Yong Wang, San Jose, CA (US)

(73) Assignee: VMware, LLC, Palo Alto, CA (US)

(21) Appl. No.: 18/378,759

(22) Filed: Oct. 11, 2023

(30) Foreign Application Priority Data
Aug. 21, 2023 (IN) 202341055837

(51) Int. Cl. H04L 41/0894; H04L 41/0816; H04L 41/0895

(52) U.S. Cl. CPC H04L 41/0894; H04L 41/0816; H04L 41/0895

(57) ABSTRACT

Some embodiments provide a novel method for configuring components of a software-defined network (SDN) to automatically deploy and monitor a logical edge router for a user. The method configures a policy parser to parse an intent-based Application Programming Interface (API) request to identify a set of attributes for the logical edge router. The method also configures a set of multi-cloud edge orchestrators (1) to use the set of attributes to derive an edge deployment plan specifying a set of two or more edge instances to implement the logical edge router, and (2) to deploy the set of edge instances in a set of two or more clouds based on the edge deployment plan.

### BACKGROUND

Edge instances and edge clusters are currently deployed either as virtual machines (VM) clusters or using bare metal instances manually by a user. The user is also responsible for capacity management of the edge cluster, namely monitoring edge instance utilization for both configuration and traffic limits, adding more edge instances and/or clusters (if necessary), placing services across edge instances, reallocating edge services across edge instances, etc. This manual process is fraught with errors and capacity related failures and outages.

Edges are currently only usable in private cloud environments. They are not currently supported in native public cloud environments, such as Amazon Web Services (AWS), Azure, Google Cloud Platform (GCP), etc. Additionally, when edge clusters are used in logical service configurations, the services do not provide an integrated view of presence of the redundant configuration for high availability (HA). Hence, methods and systems are needed for automatically deploying and scaling edge clusters in public cloud environments.

### BRIEF SUMMARY

Some embodiments provide a novel method for automatically deploying and monitoring logical forwarding elements (LFEs) for network administrators. To represent an LFE that a network administrator wants to implement, the method defines an edge object based on a first set of attributes provided by the network administrator for the LFE. The method analyzes a second set of attributes of the edge object to derive an edge deployment plan that specifies a set of two or more edge instances that implements the LFE in a set of one or more clouds. The method deploys the set of edge instances in the set of clouds. The method collects metrics associated with each edge instance in the set of two or more edge instances. The method analyzes the collected metrics to modify the edge deployment plan and revise the set of edge instances based on the modified edge deployment plan.

The method is performed in some embodiments by an orchestrator cluster that includes an edge orchestrator and a service orchestrator that deploys LFEs (e.g., logical routers, logical switches, etc.) for one or more network administrators. The orchestrator cluster in some embodiments directs one or more other applications, programs, or modules, (e.g., an edge object creator, an edge deployer, and an edge monitor) to perform one or more operations, such as the defining of the edge object, the deployment of the edge cluster (i.e., the set of edge instances), and the collecting of the metrics. These other modules in some embodiments execute within the orchestrator cluster, and in other embodiments execute as standalone modules along with the orchestrator cluster.

In some embodiments, the first set of attributes is provided by the network administrator in an Application Programming Interface (API) request. In such embodiments, the orchestrator cluster receives the API request form the network administrator through an API interface. Alternatively, a set of management servers (e.g., implementing a management plane) of the software defined network (SDN) in which the orchestrator executes receives the API request and provides it to the orchestrator cluster.

The first set of attributes is in some embodiments in a first format readable by the network administrator (i.e., in a human-readable format). In such embodiments, the second set of attributes is in a second format readable by an orchestrator that performs the deployment of the edge cluster. To define the edge object, the orchestrator cluster directs the edge object creator translate the first set of attributes into the second attributes. As such, the edge object includes the second set of attributes, which are in a format readable by the orchestrator cluster.

In some embodiments, the second set of attributes of the edge object includes (1) a human-readable identifier (ID) to identify the set of edge instances, (2) a display name, (3) a description, (4) one or more edge instance settings, (5) a deployment type specifying one or more types of cloud environments in which to deploy the LFE, and (6) one or more deployment specifications. These attributes are the criteria the network administrator wishes to use for the LFE.

The one or more deployment specification includes at least one of placement parameters, a management network configuration, a virtual local area network (VLAN) network configuration, and an overlay network configuration. These deployment specifications vary depending on the deployment type specified in the first and second attributes (i.e., vary depending on whether the edge cluster is to be deployed in a private cloud environment or a public cloud environment).

For instance, when the deployment type specifies a private cloud, the placement parameters include a first specification of a compute manager, a second specification of a management cluster, and a third specification of one or more data stores. The management network configuration includes a fourth specification of distributed port groups (dvPGs) or logical switches, a fifth specification of one or more Internet Protocol (IP) address ranges, and a sixth specification of one or more gateway addresses. The VLAN network configuration includes a seventh specification of a trunk dvPG or a logical switch and an eighth specification of a VLAN number or a VLAN range. The overlay network configuration includes a ninth specification of a dvPG or a logical switch, a tenth specification of an IP address list or subnet, an eleventh uplink profile, and a twelfth teaming policy uplink mapping. Using these deployment specifications defined in the edge object, the orchestrator cluster is able to derive the edge deployment plan and deploy the edge cluster.

When the deployment type specifies a private cloud, the placement parameters comprise a first specification of a cloud account and a second specification of a virtual private cloud (VPC) ID. The management network configuration includes a third specification of a first subnet ID. The VLAN network configuration comprises a fourth specification of a second subnet ID. When the deployment type is a public cloud, an overlay network configuration is not specified, as the public cloud does not use an overlay network to communicate within the public cloud.

The one or more edge instance settings defined in the second set of attributes includes in some embodiments one or more of edge instance size, central processing unit (CPU) allocation, and memory allocation. Using these attributes, the orchestrator cluster is able to determine the exact configuration of each edge instance to deploy to implement the LFE.

More specifically, the orchestrator cluster in some embodiments analyzes the second set of attributes to derive the edge deployment plan by analyzing the second set of attributes to determine, for the edge deployment plan, (1) a particular number of edge instances to include in the set of edge instances, (2) a particular edge instance size for each edge instance, (3) a particular amount of CPU to allocate to each edge instance, (4) a particular amount of memory to allocate to each edge instance, and (5) a particular location to deploy each edge instance.

Each particular location for each edge instance specified in the edge deployment plan specifies one of a particular private cloud or a particular public cloud. Each particular location for each edge instance specified in the edge deployment plan in some embodiments further specifies one of a particular failure domain of a particular private cloud or a particular availability zone (AZ) of a particular public cloud. In some embodiments, each particular location is also specified in the edge object, as the network administrator defined in the first set of attributes one or more particular cloud environments (e.g., a particular private cloud, such as vSphere offered by VMware, inc., a particular public cloud, such as Amazon Web Services (AWS), Azure, Google Cloud Platform (GCP), etc.). In other embodiments, each particular location is determined by the orchestrator cluster, as the network administrator only defined whether the cloud environment is to be a public cloud or a private cloud in the first set of attributes.

In some embodiments, the edge cluster (i.e., the set of edge instances) is deployed in the set of clouds based on the edge deployment plan. Because the edge deployment plan specifies the exact configuration of the set of edge instances to deploy in order to implement the LFE, the orchestrator cluster uses the edge deployment plan to deploy the edge cluster. In some embodiments, the orchestrator cluster directs the edge deployer to deploy the set of edge instances. In other embodiments, the orchestrator cluster deploys the set of edge instances itself.

The collected metrics in some embodiments include at least one of CPU metrics associated with each edge instance and memory metrics associated with each edge instance. Any suitable metrics for an edge instance can be collected and analyzed. Conjunctively or alternatively, the collected metrics include metrics related to the data messages and data message flows traversing the edge cluster, and/or the source and destination machines and host computers of the data message flows. Any suitable metrics related to data message flows and source and destination machines can be collected for analyzation.

In some embodiments, the orchestrator cluster analyzes the collected metrics to modify the edge deployment plan and revise the set of edge instances by (1) determining that a particular CPU usage of a particular edge instance has exceeded a particular threshold, (2) modifying the edge deployment plan to specify at least one additional edge instance to alleviate a load on the particular edge instance, and (3) deploying the at least one additional edge instance to implement the LFE. By analyzing the metrics to determine when to add additional edge instances to the set of edge instances implementing the LFE, the orchestrator cluster monitors and modifies the edge cluster for the network administrator, rather than the network administrator having to manually monitor and modify it.

The set of clouds in some embodiments includes at least one private cloud. In some of these embodiments, the set of clouds further includes at least one public cloud, such that the set of edge instances spans at least one private cloud and at least one public cloud. In other embodiments, the set of clouds includes at least one public cloud but no private clouds, such that the set of edge instances spans only one or more public clouds. Still, in other embodiments, the set of clouds includes at least one private cloud but no public clouds, such that the set of edge instances spans only one or more private clouds.

Each edge instance is one of a virtual machine (VM), a pod, or a container. Each edge machine is implemented on a host computer. In some embodiments, all edge instances are deployed on different host computers. In other embodiments, at least two edge instances are deployed on at least one same host computer. The set of edge instances performs at least one of routing, firewall services, load balancing services, network address translation (NAT) services, intrusion detection system (IDS) services, intrusion prevention system (IPS) services, virtual private network (VPN) services, and virtual tunnel endpoint (VTEP) services for data message flows traversing the set of edge instances to implement the LFE. In some embodiments, each edge instance performs the same set of one or more services. In other embodiments, each edge instance performs a different set of one or more services. Still, in other embodiments, at least two edge instances perform at least one same service and at least one different service.

Some embodiments provide a novel method for configuring components of an SDN to automatically deploy and monitor a logical edge router for a user. The method configures a policy parser to parse an intent-based API request to identify a set of attributes for the logical edge router. The method also configures a set of multi-cloud edge orchestrators (1) to use the set of attributes to derive an edge deployment plan specifying a set of two or more edge instances to implement the logical edge router, and (2) to deploy the set of edge instances in a set of two or more clouds based on the edge deployment plan.

The policy parser is configured in some embodiments to receive the intent-based API request to parse and identify the set of attributes for the logical edge router. In such embodiments, the policy parser receives the intent-based API request from the user through an API interface. The policy parser is in some embodiments a policy as a service module.

In some embodiments, the set of attributes used to derive the edge deployment plan is a first set of attributes. In such embodiments, the edge orchestrator is configured to use the first set of attributes to derive the edge deployment plan by configuring the edge orchestrator (1) to define an edge object based on the first set of attributes for the logical edge router and (2) to analyze a second set of attributes of the edge object to derive the edge deployment plan. The first set of attributes in these embodiments is in a first format readable by the user, and the second set of attributes is in a second format readable by the edge orchestrator. The edge orchestrator defines the edge object by translating the first set of attributes into the second set of attributes.

The edge orchestrator is configured to analyze the second set of attributes to derive the edge deployment plan by configuring the edge orchestrator to analyze the second set of attributes to determine, for the edge deployment plan, various attributes of the set of edge instances. Examples of such attributes include (1) a particular number of edge instances to include in the set of edge instances, (2) a particular edge instance size for each edge instance, (iii) a particular amount of central processing unit (CPU) to allocate to each edge instance, (iv) a particular amount of memory to allocate to each edge instance, and (v) a particular location to deploy each edge instance. These attributes are used by the edge orchestrator to deploy the set of edge instances according to the first set of attributes provided by the user in the intent-based API request.

In some embodiments, the set of multi-cloud edge orchestrators includes a public cloud edge orchestrator and a private cloud edge orchestrator. These different edge orchestrators deploy edge instances in the different cloud environments. The set of multi-cloud edge orchestrators can include any number of public and private cloud edge orchestrators. For example, the multi-cloud edge orchestrator set in some embodiments includes multiple public cloud edge orchestrators that are each associated with a different public cloud. The multi-cloud edge orchestrator set can conjunctively or alternatively include multiple private cloud edge orchestrators that are each associated with a different private cloud.

The method configures the set of multi-cloud edge orchestrators to deploy the set of edge instances in the set of clouds in some embodiments by configuring the public cloud edge orchestrator to deploy the set of edge instances in a set of two or more public clouds. In such embodiments, the logical edge router is implemented by edge instances deployed on only public cloud environments. In other embodiments, the method configures the set of multi-cloud edge orchestrators to deploy the set of edge instances in the set of clouds by configuring the private cloud edge orchestrator to deploy the set of edge instances in a set of two or more private clouds. In these embodiments, the logical edge router is implemented by edge instances deployed on only private cloud environments.

Still, in other embodiments, the method configures the set of multi-cloud edge orchestrators to deploy the set of edge instances in the set of clouds by (1) configuring the public cloud edge orchestrator to deploy a first subset of the set of edge instances in a set of one or more public clouds, and (2) configuring the private cloud edge orchestrator to deploy a second subset of the set of edge instances in a set of one or more private clouds. In such embodiments, the logical edge router is implemented by edge instances deployed in both private and public cloud environments.

In some embodiments, the method also configures a service orchestrator to collect metrics associated with each edge instance and analyze the collected metrics to perform capacity management and service placement for the logical edge router. In such embodiments, the service orchestrator is configured with (1) a capacity management module to monitor capacity of each of the set of edge instances based on the collected metrics and (2) a service placement module deploy services on one or more of the set of edge instances based on the collected metrics.

The service placement module is configured to collect a first set of metrics before deployment of the set of edge instances that implement the logical edge router. This first set of metrics is used to determine where each service that is to be implemented by the logical edge router should be deployed (i.e., on which edge instance each service should be deployed).

The capacity management module is configured to collect a second set of metrics after deployment of the set of edge instances to modify the edge deployment plan and the deployment of the set of edge instances. This second set of metrics is used to monitor the capacity of each edge instances to determine when the edge orchestrator should modify the edge instances implementing the logical edge router.

In some embodiments, the service placement module is configured to collect the first set of metrics associated with each edge instance in the set of edge instances and analyze the collected metrics to determine which edge instance should perform each services. In such embodiments, the service placement module, after determining which edge instance should perform a service, deploys the service on that edge instance. Examples of services performed for data message flows traversing the set of edge instances to implement the logical edge router include routing, firewall services, load balancing services, NAT services, IDS services, IPS services, VPN services, and VTEP services. Any suitable services (e.g., middlebox services) can be deployed on a set of edge instances implementing a logical edge router.

The second set of metrics in some embodiments includes at least one of CPU metrics associated with each edge instance and memory metrics associated with each edge instance. Such metric types can be used by the capacity management module to monitor the capacity of CPU and memory of the edge instances.

In some embodiments, the capacity management module is configured to analyze the second set of metrics to determine that a particular CPU usage of a particular edge instance has exceeded a particular threshold. In such embodiments, the capacity management module is also configured (1) to modify the edge deployment plan to specify at least one additional edge instance to alleviate load on the particular edge instance and (2) to provide the modified edge deployment plan to the edge orchestrator.

The edge orchestrator in such embodiments is configured to (1) receive the modified edge deployment plan from the capacity management module, and (2) deploy the at least one additional edge instance to implement the logical edge router. By modifying the edge deployment plan and directing the deployment of the additional edge instance or instances, the capacity management module ensures that the particular edge instances is not overloaded (e.g., with data messages it has to forward and/or process, such as performing services).

In some embodiments, the service orchestrator is part of an SDN realization layer. In such embodiments, the service orchestrator is configured to receive the first set of attributes from the policy parser to provide to the edge orchestrator after determining that the logical edge router has not yet been deployed. After the policy parser identifies the first set of attributes, the policy parser provides the first set of attributes to the service orchestrator. The service orchestrator examines the first set of attributes to determine whether it is in relation to the deployment of a new logical edge router, the modification of a deployed logical edge router, or the deployment of a service on an already deployed logical edge router.

If the service orchestrator determines that the first set of attributes is in relation to the deployment of a service on an already deployed logical edge router, the service orchestrator can use the first set of attributes (e.g., using the service placement module) to deploy that service. If the service orchestrator determines that the first set of attributes is for the deployment of a new logical edge router or the modification of a deployed logical edge router, the service orchestrator provides the first set of attributes to the edge orchestrator to handle the deployment or modification.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings, and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates an example system for using user-defined criteria to deploy a logical router as an edge cluster.

FIG. 2 illustrates a process of some embodiments for providing, for a network administrator, automatic deployment and monitoring of an edge cluster representing an LFE.

FIG. 3 illustrates an example private cloud edge object and an example public cloud edge object.

FIG. 4 conceptually illustrates a process of some embodiments for directing deployment of logical services using edge objects.

FIG. 5 illustrates edge and service orchestrators that deploy edge clusters based on logical router configuration requests received from users.

FIG. 6 illustrates edge and service orchestrators that deploy edge clusters in a set of public clouds.

FIG. 7 illustrates edge and service orchestrators that direct agents in a set of public clouds to deploy edge clusters in the set of public clouds.

FIG. 8 illustrates an edge cluster deployed across a set of AZs.

FIG. 9 illustrates a more detailed view of an edge cluster deployed across a set of AZs.

FIG. 10 illustrates an example environment for utilizing an SDN to deploy edge clusters for multiple clients.

FIG. 11 illustrates an example shared edge cluster for deploying services for first and second tenants and an example dedicated edge cluster for deploying services for only the first tenant.

FIG. 12 conceptually illustrates process of some embodiments for deploying an edge cluster using an edge orchestrator.

FIG. 13 illustrates a cloud computing virtualization platform data protection and a workload domain at different ends of a cloud boundary.

FIG. 14 illustrates an example edge orchestrator that deploys edge clusters in various cloud environments.

FIG. 15 illustrates a physical representation of a host and a four-PNIC design for the host.

FIG. 16 illustrates a logical representation of ToR switches connecting to edge instances of an edge cluster.

FIG. 17 illustrates an example edge logical router of a logical network implemented as a set of edge FEs in a set of VPCs.

FIG. 18 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel method for automatically deploying and monitoring logical forwarding elements (LFEs) for network administrators. To represent an LFE that a network administrator wants to implement, the method defines an edge object based on a first set of attributes provided by the network administrator for the LFE. The method analyzes a second set of attributes of the edge object to derive an edge deployment plan that specifies a set of two or more edge instances that implements the LFE in a set of one or more clouds. The method deploys the set of edge instances in the set of clouds. The method collects metrics associated with each edge instance in the set of two or more edge instances. The method analyzes the collected metrics to modify the edge deployment plan and revise the set of edge instances based on the modified edge deployment plan.

The method is performed in some embodiments by an orchestrator cluster that includes an edge orchestrator and a service orchestrator that deploys LFEs (e.g., logical routers, logical switches, etc.) for one or more network administrators. The orchestrator cluster in some embodiments directs one or more other applications, programs, or modules, (e.g., an edge object creator, an edge deployer, and an edge monitor) to perform one or more operations, such as the defining of the edge object, the deployment of the edge cluster (i.e., the set of edge instances), and the collecting of the metrics. These other modules in some embodiments execute within the orchestrator cluster, and in other embodiments execute as standalone modules along with the orchestrator cluster.

In some embodiments, the first set of attributes is provided by the network administrator in an Application Programming Interface (API) request. In such embodiments, the orchestrator cluster receives the API request form the network administrator through an API interface. Alternatively, a set of management servers (e.g., implementing a management plane) of the software defined network (SDN) in which the orchestrator executes receives the API request and provides it to the orchestrator cluster.

The first set of attributes is in some embodiments in a first format readable by the network administrator (i.e., in a human-readable format). In such embodiments, the second set of attributes is in a second format readable by an orchestrator that performs the deployment of the edge cluster. To define the edge object, the orchestrator cluster directs the edge object creator translate the first set of attributes into the second attributes. As such, the edge object includes the second set of attributes, which are in a format readable by the orchestrator cluster.

In some embodiments, the second set of attributes of the edge object includes (1) a human-readable identifier (ID) to identify the set of edge instances, (2) a display name, (3) a description, (4) one or more edge instance settings, (5) a deployment type specifying one or more types of cloud environments in which to deploy the LFE, and (6) one or more deployment specifications. These attributes are the criteria the network administrator wishes to use for the LFE.

The one or more deployment specification includes at least one of placement parameters, a management network configuration, a virtual local area network (VLAN) network configuration, and an overlay network configuration. These deployment specifications vary depending on the deployment type specified in the first and second attributes (i.e., vary depending on whether the edge cluster is to be deployed in a private cloud environment or a public cloud environment).

For instance, when the deployment type specifies a private cloud, the placement parameters include a first specification of a compute manager, a second specification of a management cluster, and a third specification of one or more data stores. The management network configuration includes a fourth specification of distributed port groups (dvPGs) or logical switches, a fifth specification of one or more Internet Protocol (IP) address ranges, and a sixth specification of one or more gateway addresses. The VLAN network configuration includes a seventh specification of a trunk dvPG or a logical switch and an eighth specification of a VLAN number or a VLAN range. The overlay network configuration includes a ninth specification of a dvPG or a logical switch, a tenth specification of an IP address list or subnet, an eleventh uplink profile, and a twelfth teaming policy uplink mapping. Using these deployment specifications defined in the edge object, the orchestrator cluster is able to derive the edge deployment plan and deploy the edge cluster.

The one or more edge instance settings defined in the second set of attributes includes in some embodiments one or more of edge instance size, central processing unit (CPU) allocation, and memory allocation. Using these attributes, the orchestrator cluster is able to determine the exact configuration of each edge instance to deploy to implement the LFE.

Each particular location for each edge instance specified in the edge deployment plan specifies one of a particular private cloud or a particular public cloud. Each particular location for each edge instance specified in the edge deployment plan in some embodiments further specifies one of a particular failure domain of a particular private cloud or a particular availability zone (AZ) of a particular public cloud. In some embodiments, each particular location is also specified in the edge object, as the network administrator defined in the first set of attributes one or more particular cloud environments (e.g., a particular private cloud, such as vSphere offered by VMware, inc., a particular public cloud, such as Amazon Web Services (AWS), Azure, Google Cloud Platform (GCP), etc.). In other embodiments, each particular location is determined by the orchestrator cluster, as the network administrator only defined whether the cloud environment is to be a public cloud or a private cloud in the first set of attributes.

The collected metrics in some embodiments include at least one of CPU metrics associated with each edge instance and memory metrics associated with each edge instance. Any suitable metrics for an edge instance can be collected and analyzed. Conjunctively or alternatively, the collected metrics include metrics related to the data messages and data message flows traversing the edge cluster, and/or the source and destination machines and host computers of the data message flows. Any suitable metrics related to data message flows and source and destination machines can be collected for analyzation.

The set of clouds in some embodiments includes at least one private cloud. In some of these embodiments, the set of clouds further includes at least one public cloud, such that the set of edge instances spans at least one private cloud and at least one public cloud. In other embodiments, the set of clouds includes at least one public cloud but no private clouds, such that the set of edge instances spans only one or more public clouds. Still, in other embodiments, the set of clouds includes at least one private cloud but no public clouds, such that the set of edge instances spans only one or more private clouds.

Each edge instance is one of a virtual machine (VM), a pod, or a container. Each edge machine is implemented on a host computer. In some embodiments, all edge instances are deployed on different host computers. In other embodiments, at least two edge instances are deployed on at least one same host computer. The set of edge instances performs at least one of routing, firewall services, load balancing services, network address translation (NAT) services, intrusion detection system (IDS) services, intrusion prevention system (IPS) services, virtual private network (VPN) services, and virtual tunnel endpoint (VTEP) services for data message flows traversing the set of edge instances to implement the LFE. In some embodiments, each edge instance performs the same set of one or more services. In other embodiments, each edge instance performs a different set of one or more services. Still, in other embodiments, at least two edge instances perform at least one same service and at least one different service.

Some embodiments provide a novel method for configuring components of an SDN to automatically deploy and monitor a logical edge router for a user. The method configures a policy parser to parse an intent-based API request to identify a set of attributes for the logical edge router. The method also configures a set of multi-cloud edge orchestrators (1) to use the set of attributes to derive an edge deployment plan specifying a set of two or more edge instances to implement the logical edge router, and (2) to deploy the set of edge instances in a set of two or more clouds based on the edge deployment plan.

The policy parser is configured in some embodiments to receive the intent-based API request to parse and identify the set of attributes for the logical edge router. In such embodiments, the policy parser receives the intent-based API request from the user through an API interface. The policy parser is in some embodiments a policy as a service module.

In some embodiments, the set of attributes used to derive the edge deployment plan is a first set of attributes. In such embodiments, the edge orchestrator is configured to use the first set of attributes to derive the edge deployment plan by configuring the edge orchestrator (1) to define an edge object based on the first set of attributes for the logical edge router and (2) to analyze a second set of attributes of the edge object to derive the edge deployment plan. The first set of attributes in these embodiments is in a first format readable by the user, and the second set of attributes is in a second format readable by the edge orchestrator. The edge orchestrator defines the edge object by translating the first set of attributes into the second set of attributes. The edge orchestrator is configured to analyze the second set of attributes to derive the edge deployment plan by configuring the edge orchestrator to analyze the second set of attributes to determine, for the edge deployment plan, various attributes of the set of edge instances.

In some embodiments, the set of multi-cloud edge orchestrators includes a public cloud edge orchestrator and a private cloud edge orchestrator. These different edge orchestrators deploy edge instances in the different cloud environments. The set of multi-cloud edge orchestrators can include any number of public and private cloud edge orchestrators. For example, the multi-cloud edge orchestrator set in some embodiments includes multiple public cloud edge orchestrators that are each associated with a different public cloud. The multi-cloud edge orchestrator set can conjunctively or alternatively include multiple private cloud edge orchestrators that are each associated with a different private cloud.

The method configures the set of multi-cloud edge orchestrators to deploy the set of edge instances in the set of clouds in some embodiments by configuring the public cloud edge orchestrator to deploy the set of edge instances in a set of two or more public clouds. In such embodiments, the logical edge router is implemented by edge instances deployed on only public cloud environments. In other embodiments, the method configures the set of multi-cloud edge orchestrators to deploy the set of edge instances in the set of clouds by configuring the private cloud edge orchestrator to deploy the set of edge instances in a set of two or more private clouds. In these embodiments, the logical edge router is implemented by edge instances deployed on only private cloud environments.

Still, in other embodiments, the method configures the set of multi-cloud edge orchestrators to deploy the set of edge instances in the set of clouds by (1) configuring the public cloud edge orchestrator to deploy a first subset of the set of edge instances in a set of one or more public clouds, and (2) configuring the private cloud edge orchestrator to deploy a second subset of the set of edge instances in a set of one or more private clouds. In such embodiments, the logical edge router is implemented by edge instances deployed in both private and public cloud environments.

In some embodiments, the method also configures a service orchestrator to collect metrics associated with each edge instance and analyze the collected metrics to perform capacity management and service placement for the logical edge router. In such embodiments, the service orchestrator is configured with (1) a capacity management module to monitor capacity of each of the set of edge instances based on the collected metrics and (2) a service placement module deploy services on one or more of the set of edge instances based on the collected metrics.

The service placement module is configured to collect a first set of metrics before deployment of the set of edge instances that implement the logical edge router. This first set of metrics is used to determine where each service that is to be implemented by the logical edge router should be deployed (i.e., on which edge instance each service should be deployed).

The capacity management module is configured to collect a second set of metrics after deployment of the set of edge instances to modify the edge deployment plan and the deployment of the set of edge instances. This second set of metrics is used to monitor the capacity of each edge instances to determine when the edge orchestrator should modify the edge instances implementing the logical edge router.

In some embodiments, the service orchestrator is part of an SDN realization layer. In such embodiments, the service orchestrator is configured to receive the first set of attributes from the policy parser to provide to the edge orchestrator after determining that the logical edge router has not yet been deployed. After the policy parser identifies the first set of attributes, the policy parser provides the first set of attributes to the service orchestrator. The service orchestrator examines the first set of attributes to determine whether it is in relation to the deployment of a new logical edge router, the modification of a deployed logical edge router, or the deployment of a service on an already deployed logical edge router.

If the service orchestrator determines that the first set of attributes is in relation to the deployment of a service on an already deployed logical edge router, the service orchestrator can use the first set of attributes (e.g., using the service placement module) to deploy that service. If the service orchestrator determines that the first set of attributes is for the deployment of a new logical edge router or the modification of a deployed logical edge router, the service orchestrator provides the first set of attributes to the edge orchestrator to handle the deployment or modification.

SDN edge instances and clusters provide edge and gateway services, such as routing, firewall services, IDS services, IPS services, NAT services, VPN services, VTEP services, etc. Edge instances and edge clusters are in some embodiments deployed as VMs or in other embodiments using bare metal instances, which are typically manually configured by a user. The user is also responsible for monitoring and capacity management, i.e., (1) monitoring edge instance utilization for both configuration and traffic limits, (2) adding more edge instances and/or clusters, if necessary, (3) placing services across them, etc. This manual process is fraught with errors and capacity related failures and outages. Additionally, deploying standalone edges without an overlay is currently unsupported. Edges are also currently usable within private cloud environments (e.g., vSphere offered by VMware, inc.) but within native public cloud environments such as AWS, Azure, GCP, etc.

In some embodiments, scalable edges are deployed in a Software as a Service (SaaS) environment (1) to provide less steps for a user to configure, manage, and expand the environment, (2) to monitor capacity at the SDN and expands the edge cluster automatically, (3) to intelligently scale the edge cluster, (4) to optimize operational time and reduces cost, and (5) to provide elastic public cloud solutions. An edge cluster is in some embodiments deployed in a private datacenter environment or in a public cloud environment in different embodiments.

As used in this document, references to L2, L3, L4, L5, L6, and L7 layers (or Layer 2, Layer 3, Layer 4, Layer 5, Layer 6, or Layer 7) are references respectively to the second data link layer, the third network layer, the fourth transport layer, the fifth session layer, the sixth presentation layer, and the seventh application layer of the OSI (Open System Interconnection) layer model.

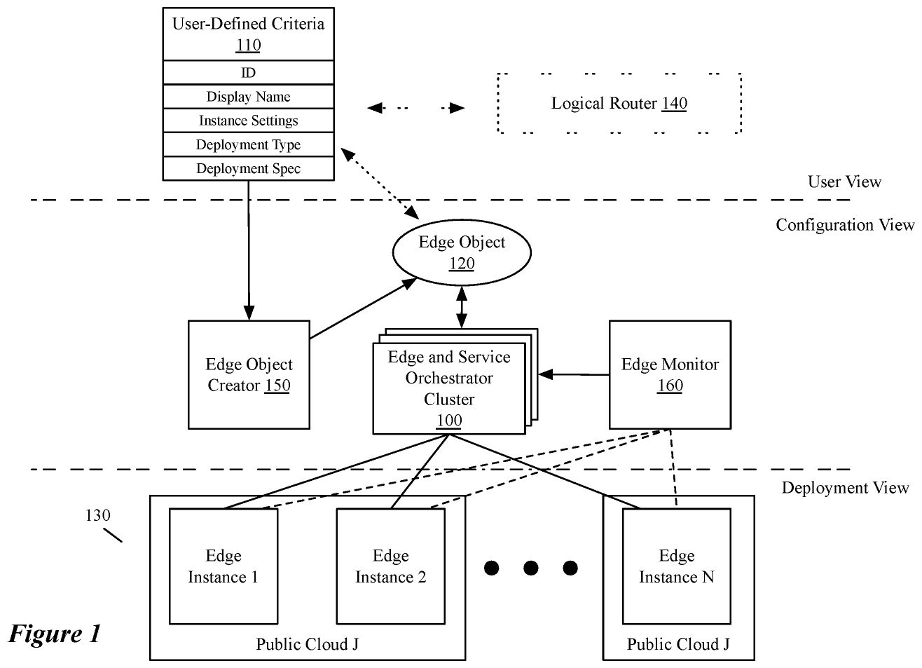

FIG. 1 illustrates an example edge and service orchestrator cluster 100 for deploying logical routers as edge clusters for users. In this example, the edge and service orchestrator cluster 100 uses an edge object creator 150 and an edge monitor 160 to deploy and monitor an edge cluster 130. A network administrator (also referred to as a user or a tenant) defines a set of user-defined criteria 110 for deploying a logical router 140. The user-defined criteria 110 specifies (1) an ID (e.g., a human-readable ID used to name the edge cluster 130), (2) a display name, (3) a description, (4) any instance settings, (5) a deployment type (e.g., private cloud (e.g., vSphere offered by VMware inc.), public cloud (e.g., AWS, Azure, GCP, etc.)), and (6) a deployment specification (e.g., placement parameters, management network configuration, VLAN network configuration, overlay network configuration, and failure domains).

The user-defined criteria 110 is received in some embodiments at the edge object creator 150 in an Application Programming Interface (API) request. In other embodiments, it is received in an API request at the edge and service orchestrator cluster 100, which provides it to the edge object creator 150. The user-defined criteria 110 includes attributes the network administrator wishes to implement for the logical router 140, and is in a first format readable by the network administrator (i.e., a human-readable format).

Using the received criteria 110, the edge object creator 150 in the configuration view configures an edge object 120, which is used by the edge and service orchestrator 100 to deploy the edge cluster 130 as a set of one or more edge instances. The edge object creator 150 can execute within the edge and service orchestrator 100 or as a separate application, program, or module. The edge object 120 is created from the user-defined criteria 110 to translate the attributes in the first format into a second format that is readable by the edge and service orchestrator cluster 100.

In some embodiments, the edge and service orchestrator cluster 100 derive the deployment plan for the edge cluster 130 based on the edge object 120 and deploy the edge cluster 130. In other embodiments, after deriving the deployment plan, the edge and service orchestrator cluster 100 directs an edge deployer to deploy the edge cluster 130. The edge deployer can execute within the edge and service orchestrator 100 or as a separate application, program, or module.

The edge cluster 130 can include any number of instances. Each edge instance is deployed to meet the user-defined criteria 110. Each edge instance can be deployed in a private cloud or a public cloud. In this example, edge instances 1 and 2 are deployed in public cloud 1, and edge instance N is deployed in public cloud J. Any number of edge instances can be deployed in each cloud environment (e.g., private cloud, public cloud) spanned by an edge cluster.

The deployment specification received in the criteria 110 includes different criteria depending on which cloud environment (e.g., private or public) the network administrator specifies as the deployment type in the criteria 100. For instance, when the network administrator specifies the deployment type as a private cloud (e.g., vSphere offered by VMware, inc.), the placement parameters include, which compute manager to use (if the private cloud has more than one compute manager available), which management server cluster (e.g., vCenter (VC) cluster offered by VMware, inc.) or resource pool to use, and/or which data store or data stores to use. The network administrator specifies placement parameters for each failure domain they wish to deploy the edge cluster.

In some of these embodiments, homogeneous networking and datastore connectivity is needed for all hosts in the management server cluster. In some embodiments, if the network administrator does not set up the needed reservations, the edge and service orchestrator cluster 100 will adjust reservations as new edge instances are added to the edge cluster 130 created using the edge object 120. A resource pool is managed in some embodiments by the service orchestrator so that the needed memory and CPU reservations on the resource pool are managed when new instances are added or when existing instances are deleted. In some embodiments, multiple types of network settings are specified per failure domain.

The management network configuration for a private cloud specifies, for each failure domain, in some embodiments (1) any dvPGs or logical switches, (2) IP address ranges, IP address pool ranges, or IP pool IDs, and (3) gateway addresses. In some embodiments, a first Ethernet interface (eth0) is the edge VNIC used for a management interface. Using this information, the edge and service orchestrator cluster 100 assigns IP addresses from the range or pool provided in the edge object 120 to each edge instance it will deploy based on the criteria 110. In some embodiments, after deployment of the edge cluster 130, the network administrator is able to see which IP addresses from the defined range or pool have been allocated and which are unassigned. Conjunctively or alternatively, the network administrator is able to add more ranges in the specified IP pool by providing them to the edge object creator 150 to modify the edge object 120.

One VLAN network is defined for each failure domain in some embodiments. The VLAN network is used in each failure domain as the external facing interface of the edge cluster, and is used by each edge instance in each failure domain to communicate with other edge instances in other failure domains and with components that are not part of the edge cluster (e.g., source and destination machines (e.g., VMs, pods, containers, etc.), other edge clusters, forwarding elements (e.g., routers, switches, gateways), etc.). In some embodiments, a VLAN network is used for T0 uplinks. In other embodiments, a service VLAN network is used for cloud service providers and L2 bridges. For a private cloud, the network administrator specifies in the VLAN network configuration of the deployment specification (1) a trunk dvPG or logical switch, and (2) a VLAN number or range (e.g., for logical router ports or segment VLANs). In some embodiments, the VLAN number is the trunk VLAN range of the dvPG or SDN logical switch.

One overlay network is defined for each failure domain in some embodiments. An overlay network is used in each failure domain for each edge instance within the failure domain to communicate with each other. In some embodiments, an overlay network is not defined for a public cloud, as the edge cluster needs to be able to be deployed without any overlay configurations. For a private cloud, the network administrator in some embodiments specifies in the overlay network configuration of the deployment specification (1) a dvPG or logical switch, (2) an IP address list, an IP gateway, a subnet mask, or an IP pool ID or subnet(s) (e.g., for VTEPs), (3) an uplink profile (e.g., transport VLAN, maximum transmission unit (MTU), teaming policy (load balancing, failover, hierarchical two-tier (MTEP)), and (4) a teaming policy uplink mapping.

In some embodiments, a tunnel endpoint (TEP) IP range or subnet or an IP pool ID is used for IP address management (IPAM) or an edge host switch. If the user provides a range, the edge object creator 150, in some embodiments, creates an IP pool from the specified IP range which allows the edge and service orchestrator cluster 100 to use the created IP pool to assign and release IP addresses as required. After deployment of the edge cluster 130, in some embodiments, the network administrator is able to see which IP addresses from the defined range or pool have been allocated and which are unassigned. Conjunctively or alternatively, the network administrator is able to add more ranges in the specified IP pool by providing them to the edge object creator 150 which will update the edge object 120.

The placement parameters, management network configuration, VLAN network configuration, and overlay network configuration are different when the network administrator specifies a public cloud (e.g., AWS, Azure, GCP, etc.) in the criteria 110. For instance, when the network administrator wishes to deploy the edge cluster 130 in the public cloud, the network administrator specifies for the placement parameters in some embodiments (1) a cloud account, and (2) a Virtual Private Cloud (VPC) ID. This information is specified for each AZ the network administrator wishes to deploy the edge cluster 130.

For the management network configuration in a public cloud, the network administrator in some embodiments specifies a subnet ID, and the edge and service orchestrator cluster 100 assigns one or more IP addresses to the edge cluster 130 and its instances based on the subnet associated with the subnet ID. Conjunctively or alternatively, the edge and service orchestrator cluster 100 assigns IP addresses to default routes based on this subnet.

A VLAN network is used in each AZ as the external facing interface of the edge cluster, and is used by each edge instance in each AZ to communicate with other edge instances in other AZs and with components that are not part of the edge cluster (e.g., source and destination machines (e.g., VMs, pods, containers, etc.), other edge clusters, forwarding elements (e.g., routers, switches, gateways), etc.). For the VLAN network configuration in a public cloud, the user in some embodiments specifies another subnet ID, which lets the edge and service orchestrator cluster 100 assign one or more IP addresses of the VLAN network using this subnet. An overlay network is not used in each AZ in some embodiments for each edge instance to communicate within their AZ.

Conjunctively or alternatively, the set of criteria 110 for private and/or public clouds includes ranges of VLANs, ranges of Internet Protocol (IP) addresses to use for network interface controllers (NICs) of the edge cluster's edge instances, a list of Border Gateway Protocol (BGP) neighbors, etc. Any suitable criteria for deploying an edge cluster to represent a logical router for a network administrator can be included in the criteria 110 received from the network administrator.

After deploying the edge cluster 130 using the edge object 120, an edge monitor 160 collects data (e.g., metrics) associated with the edge cluster 130 for the edge and service orchestrator 100 to monitor the edge cluster 130. As the network administrator does not view the deployment view of the edge cluster 130 and only sees the user view of the criteria 110 and the logical router 140, the network administrator has no perspective on the edge cluster 130 and does not have to monitor or modify it manually. As such, an equivalency between the user view and the deployment view exists, as the user view is the perspective of the network administrator and the deployment view is the actual realization of the user view by way of the components in the configuration view.

As the edge cluster 130 is automatically deployed and monitored using the edge object 120, the edge cluster 130 is not completely visible to the network administrator. Rather, the network administrator sees the edge cluster 130 from the perspective of the logical router 140. Because the edge and service orchestrator cluster 100 performs the configuration, deployment, and monitoring of the edge cluster 130 (e.g., using the edge object creator 150 and the edge monitor 160), the network administrator no longer has to manually do any of these operations.

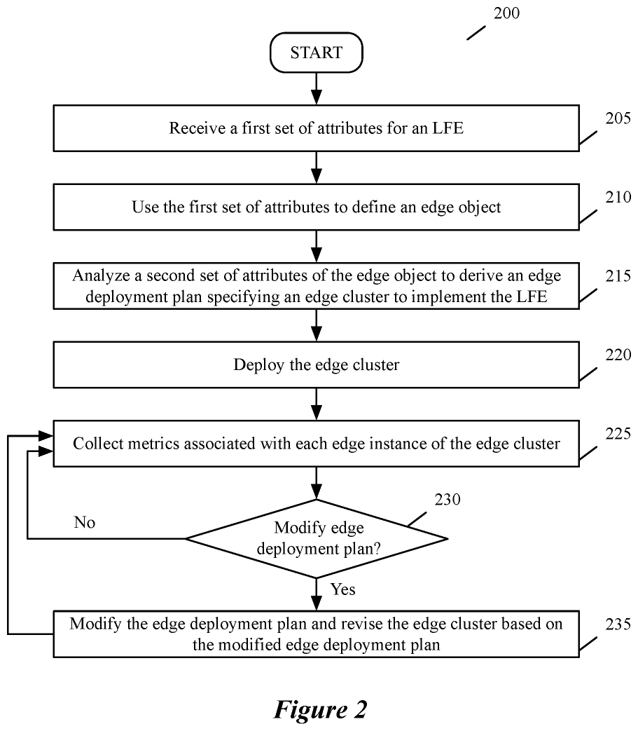

FIG. 2 conceptually illustrates a process 200 of some embodiments for providing, for a network administrator, automatic deployment and monitoring of an edge cluster that represents a LFE. The process 200 is performed in some embodiments by an orchestrator cluster of an SDN (i.e., by an edge orchestrator and a service orchestrator cluster) that deploys different edge clusters for different LFEs of different network administrators. Conjunctively or alternatively, the process 200 is performed by a set of one or more agents by direction of the orchestrator cluster. In some embodiments, an edge orchestrator of the orchestrator cluster directs the deployment and scaling of the edge cluster, and a service orchestrator of the orchestrator cluster directs the edge orchestrator to scale out the edge cluster, directs the deployment of services on the edge cluster, and manages the capacity of the edge cluster to deploy additional services on the edge cluster (e.g., using metrics collected from an edge monitor).

In some embodiments, the edge cluster is deployed in a private cloud environment (e.g., vSphere offered by VMware, inc.). In such embodiments, the edge cluster can be deployed on one or more failure domains of the private cloud. Conjunctively or alternatively, the edge cluster is deployed in at least one private cloud and at least one public cloud. In other embodiments, the edge cluster is deployed in a public cloud environment (e.g., AWS, Azure, GCP, etc.). In such embodiments, the edge cluster can be deployed in one or more AZs of the public cloud, or in one or more datacenters of the public cloud. The edge cluster in some embodiments is deployed on two or more public clouds. The edge cluster may be deployed for providing various services, such as routing, firewall, NAT, VPN, VTEP for data messages, etc.

The process 200 begins by receiving (at 205) a first set of attributes for the LFE. In some embodiments, the orchestrator cluster receives this criteria from the network administrator through an interface (e.g., in an API request). In other embodiments, the orchestrator cluster receives the first set of attributes from the SDN manager/controller cluster of the SDN, which receives it from the network administrator.

The first set of attributes is in a first format readable by the network administrator and includes, in some embodiments, an ID, a display name, instance settings, a deployment type, and a deployment specification. The first set of attributes differs based on the deployment type. For example, the first set of attributes includes some criteria when the deployment type is a private cloud, and includes other criteria when the deployment type is a public cloud.

Next, the process 200 uses (at 210) the first set of attributes to define an edge object. Using the received first set of attributes, the orchestrator cluster (e.g., by directing an edge object creator) defines the edge object that will be used to create the edge cluster based on the first set of attributes. Based on user input defined in the received first set of attributes, the edge object is created in order to translate the first set of attributes, which is in a user-readable format, to a second set of attributes in the edge object, which is in a format readable by the orchestrator cluster.

At 215, the process 200 analyzes the second set of attributes of the edge object to derive an edge deployment plan that specifies an edge cluster to implement the LFE in a set of one or more clouds. In some embodiments, the second set of attributes is analyzed by the orchestrator cluster to determine the exact configuration to the deploy the edge cluster as a set of one or more edge instances. The edge deployment plan specifies, in some embodiments, the number of edge instances to deploy for the edge instances, where to deploy each edge instance (e.g., in which cloud, failure domain, AZ, datacenter, etc.), and the configuration for each edge instance (e.g., size, CPU allocation, memory allocation, etc.).

Then, the process 200 deploys (at 220) the edge cluster in the set of one or more clouds. Using the edge deployment plan, the orchestrator cluster in some embodiments deploys the set of one or more edge instances in the set of clouds specified in the second set of attributes. Alternatively, the orchestrator cluster directs an edge deployer (executing within the orchestrator cluster or along with the orchestrator cluster) to deploy the edge cluster based on the derived edge deployment plan.

In some embodiments, the orchestrator cluster deploys one pair of edge instances for the edge cluster, with a first edge instance representing a Tier-0 (T0) logical router and a second edge instance representing a Tier-1 (T1) logical router to represent the LFE. In other embodiments, the edge orchestrator deploys multiple pairs of edge instances to represent the LFE. Each edge instance in some embodiments is a VM deployed in the environment specified in the edge object and in the edge deployment plan (i.e., in the specific private or public cloud).

In some embodiments, in deploying the edge instance pair, the orchestrator cluster connects each edge instance to the appropriate network. In such embodiments, the orchestrator cluster connects the NICs and IP addresses of the edge instances to the network in Infrastructure as a Service (IaaS). In some embodiments, the edge cluster is deployed to appear as the LFE from the perspective of the network administrator that provided the first set of attributes. In such embodiments, deploying the edge instance pairs includes deploying a service router (SR) component in each edge instance and deploying a DR component that spans each edge instance of the edge cluster.

When deploying the edge cluster in a private cloud, a first edge instance pair in some embodiments is deployed in a first failure domain including a first set of hardware components, while a second edge instance pair is deployed in a second failure domain including a second set of hardware components. These pairs of edge VMs can be configured in a high availability (HA) configuration such that if one failure domain fails, the edge cluster does not fail completely. When the orchestrator cluster knows which edge instances are deployed in which failure domain, the orchestrator cluster is considered failure domain aware.

At 225, the process 200 collects metrics associated with each edge instance in the set of instances deployed for the edge cluster. In some embodiments, the orchestrator cluster periodically retrieves the metrics from an edge monitor that collects the metrics and stores them in one or more data stores. In other embodiments, the edge monitor periodically provides the metrics to the orchestrator cluster. The collected metrics in some embodiments include metrics associated with each edge instance, such as CPU allocation metrics, CPU usage metrics, memory allocation metrics, and memory usage metrics. Any metrics associated with an edge instance or an edge cluster can be collected by the orchestrator cluster.

In some embodiments, each edge instance of the edge cluster is associated with its own set of one or more metrics. For example, CPU is a significant metric for an L7 firewall service in some embodiments, so this is monitored by the orchestrator cluster. As another example, the number of network data messages processed per second is a significant metric an L4 firewall service, so the orchestrator cluster monitors this metric for the edge instance performing this service. In some embodiments, different metric types are collected for different service types. In other embodiments, two or more services have at least one same metric type collected by the service orchestrator.

In some embodiments, the collected metrics also include metrics related to the data message flows traversing the edge cluster, such as the number of data message flows traversing the edge cluster, the number of data messages in each flow traversing the edge cluster, the type or types of services being applied at the edge cluster to the data message flows, etc. Any metrics associated with data messages and data message flows can be collected by the orchestrator cluster. Conjunctively or alternatively, the collected metrics include metrics related to the machines (e.g., VMs, pods, containers, etc.) and/or the host computers that are the sources and destinations of the data messages traversing the edge cluster. Any metrics associated with source and destination machines or source and destination host computers can be collected by the orchestrator cluster.

At 230, the process 200 determines whether the edge deployment plan for the edge cluster needs to be modified. In some embodiments, the orchestrator cluster determines that one or more additional edge instances need to be deployed, as the orchestrator cluster uses the collected metrics to monitor the edge instances for the edge cluster. For example, when the CPU usage of a particular edge instance exceeds a particular threshold (e.g., defined in the first and second sets of attributes), the orchestrator cluster will need to modify the edge cluster to alleviate the load on the particular edge instance. An additional pair of edge instances is needed to be deployed for the edge cluster in some embodiments in order to meet a set of capacity requirements for the edge cluster. For example, the orchestrator cluster in some embodiments detects that two edge instance pairs are needed in order to keep up with the amount of traffic traversing the edge cluster, so the orchestrator cluster will need to modify the edge deployment plan to include an additional edge instance pair for the edge cluster.

If the process 200 determines that the edge deployment plan does not need to be modified, the process 200 returns to step 225 to continue collecting metrics for each edge instance of the edge cluster. If the process 200 determines that the edge deployment plan does need to be modified, the process 200 modifies (at 235) the edge deployment plan and revises the edge cluster based on the modified edge deployment plan. The orchestrator cluster modifies the edge deployment plan such that the edge cluster will meet the requirements specified in the first and second sets of attributes. After modifying the edge deployment plan, the orchestrator cluster directs the edge deployer to revise the edge cluster based on the modified edge deployment plan. Alternatively, the orchestrator cluster revises the edge cluster itself based on the modified edge deployment plan.

The orchestrator cluster in some embodiments scales out the edge cluster by deploying the additional edge instance(s). By deploying additional edge instances for the edge cluster, the orchestrator cluster alleviates the load on the overloaded edge instance(s) that are already deployed. After modifying the edge deployment plan and revising the edge cluster, the process 200 returns to step 225 to continue monitoring the edge cluster.

In some embodiments, the process 200 is performed indefinitely, as the orchestrator cluster continually monitors the edge cluster for the network administrator such that the network administrator does not manually monitor or manage the edge cluster. In other embodiments, the process 200 ends after a particular period of time (e.g., specified by the network administrator).

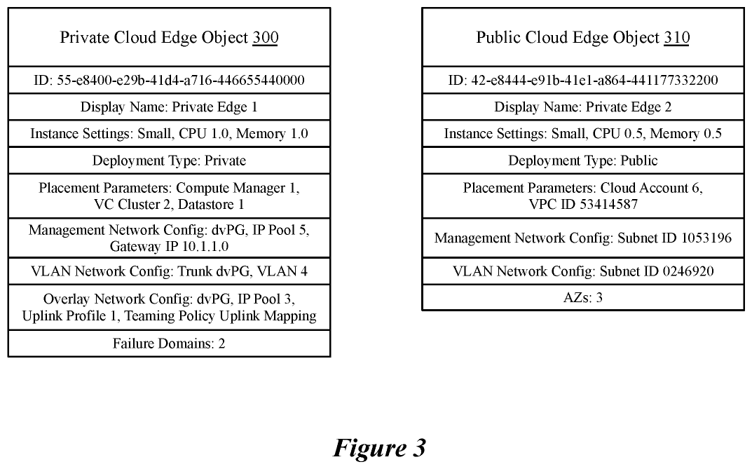

FIG. 3 illustrates two example edge objects 300 and 310 that are configured based on user-defined criteria and are used for deploying different edge clusters. The first edge object 300 is a private cloud edge object for deploying an edge cluster in a particular private cloud. The object 300 defines, for the private cloud edge cluster: an ID, a display name, edge instance settings, the deployment type, placement parameters (compute manager, VC cluster, datastores), the management network configuration (dvPG or SDN logical switches, IP range-subnet or IP pool ID, gateway address), the VLAN network configuration (dvPG or SDN logical switches, VLAN number of range), the overlay network configuration (dvPG or SDN logical switches, IP list/Gateway/Subnet mask or IP Pool ID/subnets, uplink profile, teaming policy uplink mapping), and the failure domains.

The second edge object 310 is a public cloud edge object for deploying an edge cluster in a particular public cloud. The object 310 defines, for the public cloud edge cluster: an ID, a display name, edge instance settings, the deployment type, placement parameters (cloud account, VPC ID), the management network configuration (subnet ID), the VLAN network configuration (subnet ID), and the AZs.

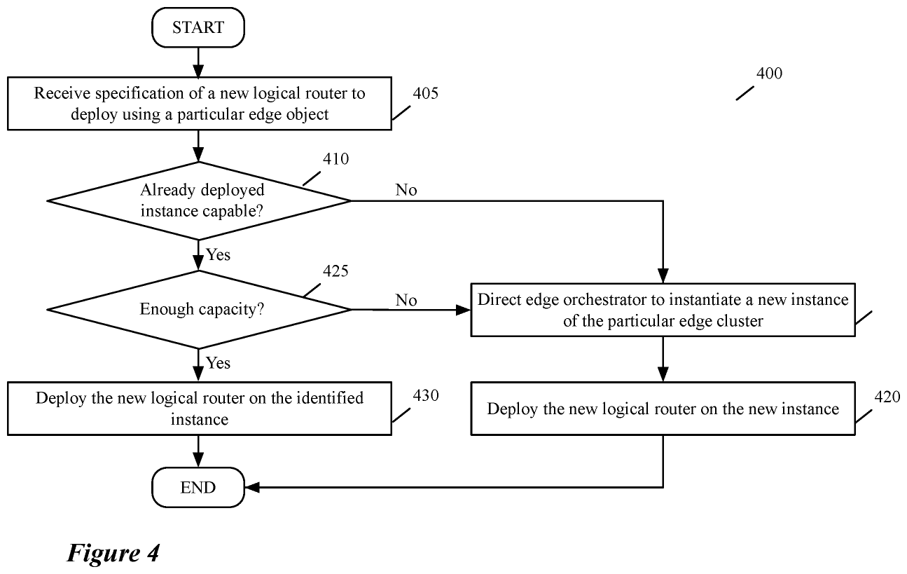

FIG. 4 conceptually illustrates a process 400 of some embodiments performed by a service orchestrator that directs deployment of services, such as logical routers, on a particular edge cluster. The process 400 is performed in some embodiments by a service orchestrator. In other embodiments, the process 400 is performed by a set of one or more agents (e.g., operating in the same public cloud as the edge cluster) as directed by the service orchestrator (e.g., operating in an SDN).

The process 400 begins by receiving (at 405) specification of a new logical router to deploy using a particular edge object. In some embodiments, a user directs the service orchestrator to implement a new logical router using the particular edge object which the user has already configured with the service orchestrator (e.g., by defining criteria). The logical router in some embodiments is specified to implement one or more services, such as routing, firewall services, NAT services, VPN services, etc. The particular edge object was previously used to deploy a particular edge cluster. In some embodiments, the particular edge cluster is deployed in a private cloud. In such embodiments, the particular edge cluster can be deployed on any number of failure domains. In other embodiments, it is deployed in a public cloud. In such embodiments, the particular edge cluster can be deployed in any number of AZs.

Next, the process 400 determines (at 410) whether the particular edge cluster associated with the particular edge object already has a deployed instance capable of implementing the new logical router. In some embodiments, different instances of an edge cluster have different capabilities. For example, different instances of an edge cluster in some embodiments are deployed as different VMs, and each VM in some embodiments has a different configuration (e.g., size, amount of CPU allocated, amount of memory allocated, failure domain or AZ in which it is deployed, etc.). As such, the service orchestrator determines if any edge instances of the particular edge cluster has a configuration capable of implementing the new logical router.

If the process 400 determines that there are no already deployed instances capable, the process 400 directs (at 415) the edge orchestrator to instantiate a new instance of the particular edge cluster associated with the particular edge object. In some embodiments, the service orchestrator directs the edge orchestrator to instantiate a new edge instance (e.g., by directing an edge deployer in some embodiments and by performing the instantiation itself in other embodiments) that meets the configuration requirements of the new logical router. After directing the edge orchestrator, the process 400 deploys (at 420) the new logical router on the new instance. In some embodiments, the service orchestrator deploys the new logical router based on the edge deployment plan associated with the particular edge object. In other embodiments, the service orchestrator directs another application, program, or module (e.g., an edge deployer, a service deployer, etc.) to deploy the new logical router. After deploying the new logical router on the new instance, the process 400 ends.

If the process 400 determines that there is an already deployed instance capable, the process 400 determines (at 425) whether the identified instance has enough capacity for the new logical router. In some embodiments, each edge instance of the particular edge cluster is able to implement different logical routers and different types of services. In such embodiments, each instance has an amount of capacity used by the logical routers and services already deployed on it, and has a threshold amount of capacity allotted for it. In some embodiments, the threshold amount of capacity is the total capacity of the instance. In other embodiments, the threshold amount of capacity is less than the total capacity of the instance.

If the process 400 determines that the identified instance does not have enough capacity for the new logical router or service, the process 400 performs the steps 415 and 420 to instantiate a new instance and deploy the new logical router on the new instance, and the process 400 ends. If the process 400 determines that the identified instances has enough capacity for the new logical router, the process 400 deploys (at 430) the new logical router on the identified instance. In some embodiments, the service orchestrator deploys the new logical router based on the edge deployment plan associated with the particular edge object. In other embodiments, the service orchestrator directs another application, program, or module (e.g., an edge deployer, a service deployer, etc.) to deploy the new logical router. After deploying the new logical router on the identified instance, the process 400 ends.

While the above described process 400 is described for deploying a new logical router on the particular edge cluster, the process 400 may be performed for any other service that can be implemented on an edge router, such as an LFE (e.g., a logical router or a logical switch) or another logical service (e.g., firewall services, load balancing services, NAT services, etc.).

In some embodiments, a service orchestrator considers factors other than capability and capacity into consideration when deploying services on an edge cluster. For example, an availability profile is associated with each edge cluster in some embodiments that specifies if a service requires active/active scale-out, active/standby scale-out, or a best effort scale-out. Depending on the availability profile of a service, the service orchestrator in such embodiments deploys the service on one or more edge instances of an edge cluster. In some embodiments, based on the failure domain or AZ defined on an edge object, the service orchestrator deploys services across the failure domain or AZ (i.e., on at least one edge instance in each failure domain or AZ).

Network connectivity is a factor the service orchestrator considers for deploying services in some embodiments. In some of these embodiments, the service orchestrator consults an analytics engine to gather details on capacity of edge instances (e.g., configuration of edge instances, resource utilization of the edge instances, etc.). Based on these metrics, the service orchestrator implements services on different edge instances of the edge cluster. If the service orchestrator requires additional capacity to deploy a service in an edge cluster, it invokes the edge orchestrator to create additional edge instances for the edge cluster. Similarly, if there is excess capacity of an edge cluster, the service orchestrator in some embodiments consolidates services deployed on the edge cluster and directs the edge orchestrator to de-commission (i.e., delete) extra edge instances from the cluster.

In some embodiments, the service orchestrator is triggered to deploy services on an edge cluster when the analytics engine determines that capacity of one or more edge instances of an edge cluster exceeds a particular threshold. In such embodiments, the service orchestrator reviews and moves services so as to use all existing edge instances in the edge cluster optimally. If no spare capacity is available on any of the edge instances, the service orchestrator in some embodiments directs the edge orchestrator to deploy one or more additional edge instances for the cluster. Then, the service orchestrator uses the additional edge instance or instances to implement the services instead of the edge instance or instances whose capacity is exceeding the particular threshold. The analytics engine in some embodiments performs capacity management and prediction for an edge cluster. In such embodiments, a capacity score and predictions are provided to the user.

Logical services refer to scalable edges in some embodiments as the deployment unit. In such embodiments, the service and edge orchestrators deploy edge instances as VMs and implement services on those VMs. In some embodiments, services are configured using SDN policy APIs on the SDN manager. Services are in some embodiments validated by a policy, and appropriate providers will propagate configuration to the CCP (i.e., the SDN controller) of the SDN. Then, the CCP in some embodiments propagates the configuration of the logical services to the appropriate edge instances.

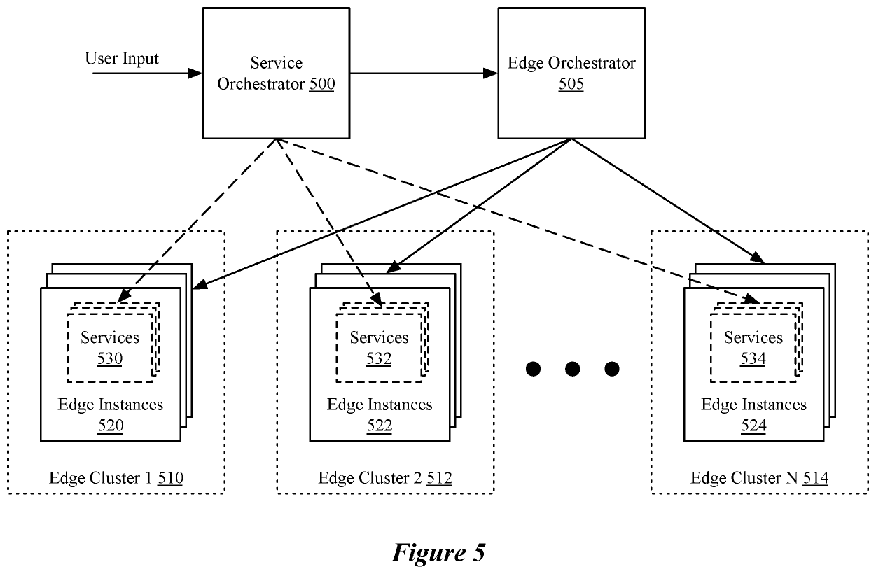

FIG. 5 illustrates an example service orchestrator 500 and edge orchestrator 505 that deploy edge clusters based on edge objects configured from user-defined criteria, implement services on the edge clusters based on user requests, and monitor the edge clusters automatically for the users. The service and edge orchestrators 500-505 deploy and manage any number of edge clusters 510-514. Each edge cluster 510-514 can include any number of edge instances 520-524, and each edge instance 520-524 can implement any number of services 530-534. The edge clusters 510-514 can each be deployed in one or more private clouds, one or more public clouds, or a combination of both.

In this example, the service orchestrator 500 receives user input (e.g., criteria for configuring edge objects, requests for new services such as logical routers, etc.). After receiving the user input, the service orchestrator 500 either performs operations based on the user input (e.g., deploy services 530-534 on the edge clusters 510-514) or directs the edge orchestrator 505 to perform operations (e.g., configure edge objects, derive edge deployment plans, deploy new edge clusters, deploy new edge instances for existing edge clusters, etc.).

In some embodiments, the edge orchestrator 505 is one edge orchestrator for deploying the edge clusters 510-514 in both private cloud and public cloud environments. In other embodiments, the edge orchestrator 505 includes a first private cloud edge orchestrator for deploying edge clusters in private cloud environments, and a second public cloud edge orchestrator for deploying edge clusters in public cloud environments. Still, in other embodiments, the edge orchestrator 505 includes a different edge orchestrator for each different private cloud environment and for each different public cloud environment. For example, the edge orchestrator 505 includes in some embodiments a first edge orchestrator for deploying edge clusters in vSphere offered by VMware, inc., a second edge orchestrator for deploying edge clusters in AWS, and a third edge orchestrator for deploying edge clusters in Azure. Like the edge orchestrator 505, the service orchestrator 500 can include a single service orchestrator or separate service orchestrators for private and public cloud environments.

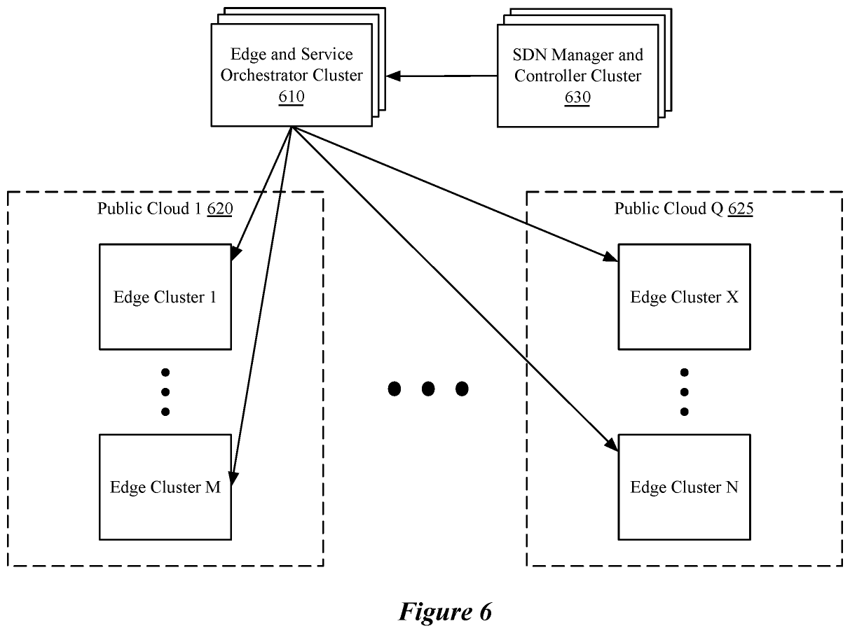

Deploying and scaling edge clusters manually by a user can result in errors and capacity failures. In order to automate these processes, an edge and service orchestrator cluster is configured in some embodiments for automatically deploying, managing, and scaling edge clusters. FIG. 6 illustrates an example edge and service orchestrator cluster 610 that deploys edge clusters in a set of public clouds 620-625. In this example, the edge and service orchestrator cluster 610 operates in an SDN environment managed by an SDN manager and controller cluster 630. From the SDN, the edge and service orchestrator cluster 610 deploys edge clusters in the public clouds 620-625. The edge and service orchestrator cluster 610 can deploy any number of edge clusters in any number of public clouds, and can deploy edge clusters across multiple AZs of one public cloud or across multiple AZs of multiple public clouds.

In some embodiments, the SDN manager and controller cluster 630 configures the edge and service orchestrator cluster 610 to deploy an edge cluster. The edge and service orchestrator cluster 610 is responsible for deploying the edge cluster based on user-defined criteria, monitoring the edge cluster and the AZs in which it is deployed, and scaling out (by adding additional edge instance pairs) and scaling up (by adding additional resources to one or more of edge instance pairs) the edge cluster. In some embodiments, modification of an edge cluster may be due to capacity requirements of the edge cluster, as specified by the user-defined criteria.

This modification may also be due to failure of one or more edge instance pairs of the cluster or failure of an entire AZ in which at least some of the edge cluster is deployed. The edge and service orchestrator cluster 610 is in some embodiments failure domain aware. A fault domain is a set of hardware components that share a single point of failure, and the edge and service orchestrator cluster 610 can be failure domain aware by deploying an edge cluster in two or more failure domains, providing high availability and redundancy for the edge cluster. For example, the edge and service orchestrator cluster 610 can deploy a first edge instance pair on a first set of hardware components, and a second edge instance pair on a second set of hardware components. These edge instance pairs can be configured in an active/standby configuration such that if one failure domain fails, the edge cluster does not fail or shut down completely.

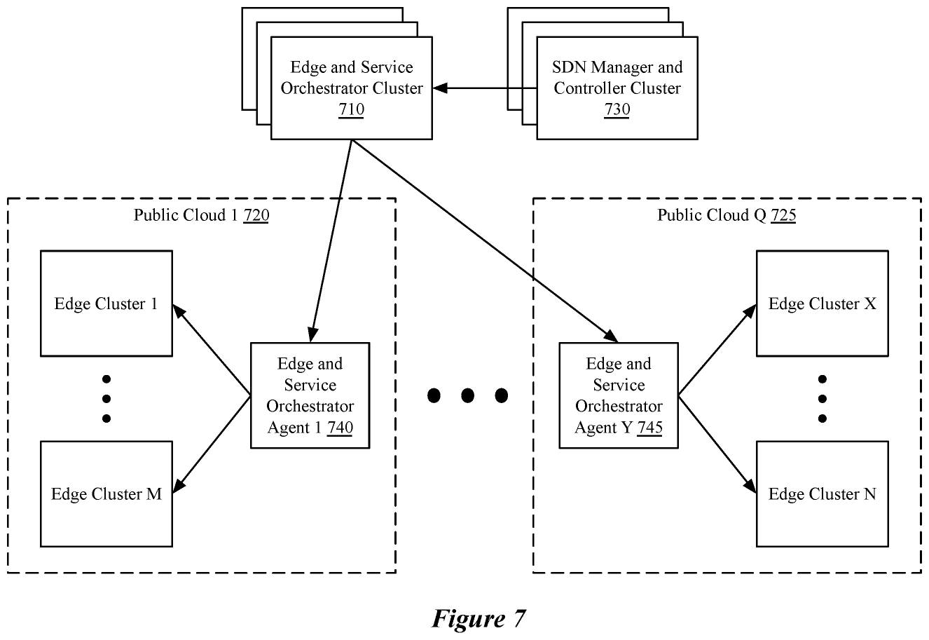

FIG. 7 illustrates another example edge and service orchestrator cluster 710 for deploying edge clusters in a set of public clouds 720-725. In this example, the edge service orchestrator 710 (1) operates in the SDN, (2) is configured and managed by the SDN manager and controller cluster 730, and (3) deploys a set of agents 740-745 in each public cloud for which the orchestrator cluster 710 deploys edge clusters. The orchestrator 710 configures the agents 740-745 to deploy and scale the edge clusters. In some embodiments, the edge and service orchestrator 710 uses user-defined criteria to direct the deployment of the edge cluster by the agents 740-745. The agents 740 and 745 receive data from the orchestrator cluster 710 pertaining to any edge clusters that are to be deployed in their respective AZ, and the agents perform the deployment. The orchestrator cluster 710 also monitors the public clouds 720-725 and the edge clusters using the agents 740-745, and direct the agents to modify any edge clusters based on the monitoring.

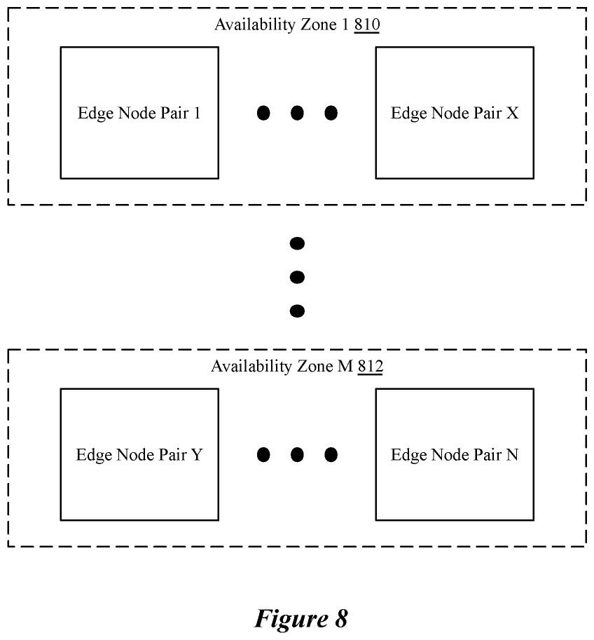

In different embodiments, one edge cluster spans varying numbers of AZs of a public cloud. FIG. 8 illustrates an edge cluster deployed across a set of M AZs 810-812 of a particular public cloud. The edge cluster can span any number of AZs of the particular public cloud. In each AZ 810-812, the edge cluster can deploy any number of edge instance pairs. In some embodiments, each AZ 810 and 812 includes the same number of edge instance pairs, while, in other embodiments, different AZs can include different numbers of edge instance pairs for the edge cluster. This set of AZs 810-812 can include AZs only from a particular public cloud provider, AZs from only one datacenter, AZs from multiple datacenters, or AZs from multiple public cloud providers.

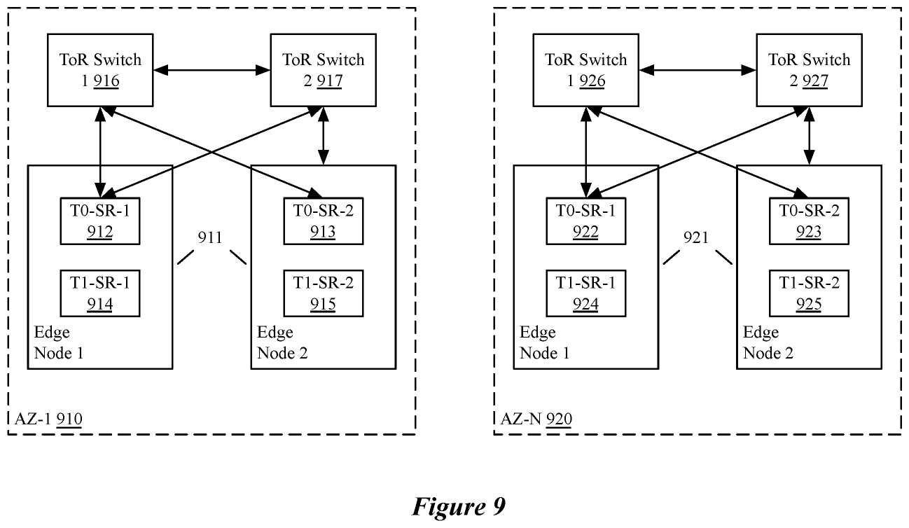

FIG. 9 illustrates a more detailed view of deploying an edge cluster in multiple AZs 910 and 920 of a particular public cloud and deploying a logical router on the edge cluster. These AZs 910 and 920 are in some embodiments zones of a same public cloud provider (e.g., AWS, Azure, GCP, etc.), and are in other embodiments zones of different public cloud providers. Each AZ 910 and 920 respectively includes a pair of edge instances 911 and 921 (also referred to as a sub-cluster in some embodiments). In some embodiments, when the edge cluster is first deployed, one edge instance pair is deployed in each AZ 910 and 920 (as shown), and as the edge cluster is scaled out to include more edge instance pairs, an AZ 910 or 920 can have multiple edge instance pairs. In other embodiments, two or more edge instance pairs are deployed in at least one AZ when the edge cluster is first deployed. In some embodiments, each AZ 910 and 920 in which the edge cluster is deployed includes the same number of edge instance pairs. In other embodiments, different AZs include different numbers of edge instance pairs, which may be based on the available capacity of the AZs. In some embodiments, individual edge instances are deployed in AZs for an edge cluster, namely, edge instances are not deployed in pairs in some embodiments.

In AZ 910, edge instances of the pair 911 each include a T0 SR 912 and 913 and a T1 SR 914 and 915 of the logical router. The T0 SRs 912 and 913 communicate with two Top of Rack (ToR) switches 916 and 917 of the AZ 910. Alternatively, an AZ includes only one ToR switch 916 for the T0 SRs 912 and 913 to connect to. In AZ 920, edge instances of the pair 921 each include a T0 SR 922 and 923 and a T1 SR 924 and 925. The T0 SRs 922 and 923 communicate with ToR switches 926 and 927 of the AZ 920. The SR components 912-915 and 922-925 are the components that make up the logical router deployed on the edge cluster. The ToR switches 916, 917, 926, and 927 communicate with the SR components 912-915 and 922-925 of the logical router for exchanging ingress and egress traffic between the edge cluster and an external network.

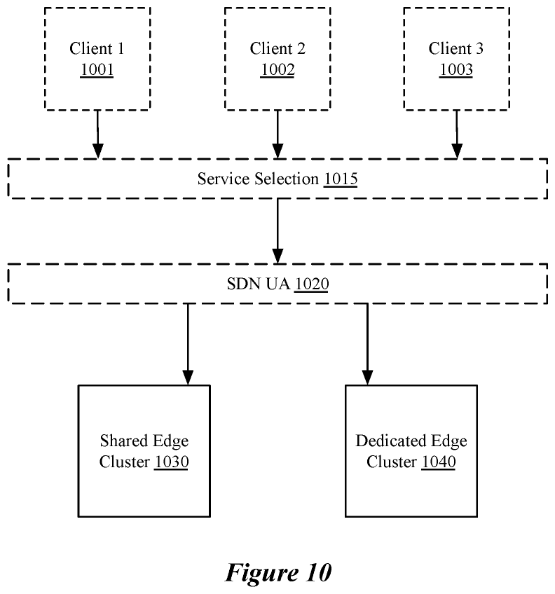

As discussed previously, edge and service orchestrators in some embodiments operate in an SDN environment to deploy edge clusters in private and public cloud environments for users wishing to deploy logical routers. FIG. 10 illustrates an example environment for utilizing an SDN to deploy edge clusters for multiple clients 1001-1003 (i.e., for multiple users). Each client 1001-1003 provides criteria (i.e., edge objects) for deploying their logical routers (i.e., for deploying their) edge cluster or clusters, which is received by the SDN unified architecture (UA) 1020. This user-defined criteria in some embodiments includes service selections, as denoted by the service selection 1015.

The SDN UA 1020 uses the received client criteria to deploy different edge clusters in the SDN. In this example, the SDN UA 1020 deploys a shared edge cluster 1030 for clients 1001 and 1002, and a dedicated edge cluster 1040 for client 1003. After automatically deploying the edge clusters 1030 and 1040 for the clients 1001-1003, the SDN UA 1020 in some embodiments automatically selects and scales the edge clusters 1030 and 1040.

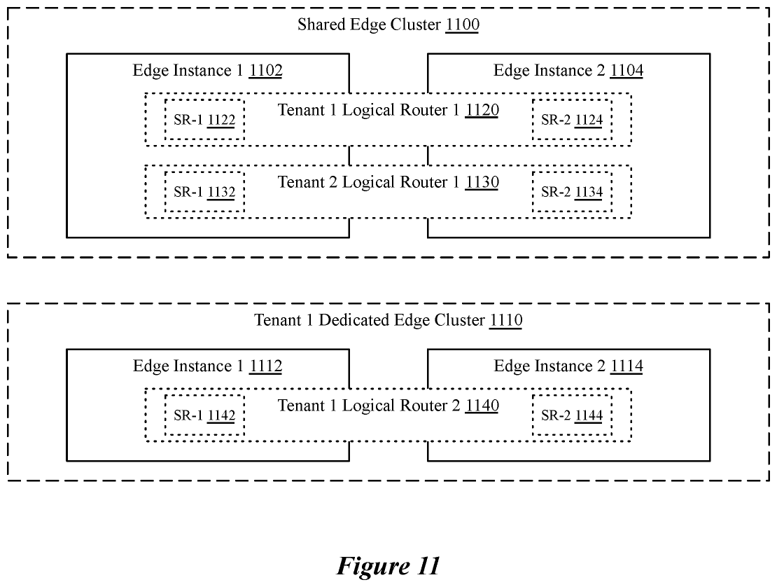

FIG. 11 illustrates a shared edge cluster 1100 used by first and second tenants and a dedicated edge cluster 1110 used by only the first tenant. The shared edge cluster 1100 includes two edge instances 1102 and 1104. While only two edge instances are illustrated for the shared edge cluster 1100, one of ordinary skill would understand that a shared edge cluster can include any number of edge instances. Edge instances 1102-1104 deploy a first logical router 1120 for a first tenant. In this example, a first SR component 1122 is deployed on the first edge instance 1102 and a second SR component 1124 is deployed on the second edge instance 1104. In some embodiments, each SR component 1122-1124 includes one T0 SR component and one T1 SR component. In other embodiments, at least one SR component 1122-1124 includes only one T0 or T1 SR component.

Edge instances 1102-1104 also deploy a second logical router 1130 for a second tenant. In this example, a first SR component 1132 is deployed on the first edge instance 1102 and a second SR component 1134 is deployed on the second edge instance 1104. In some embodiments, each SR component 1132-1134 includes one T0SR component and one T1 SR component. In other embodiments, at least one SR component 1132-1134 includes only one T0 or T1 SR component.

The dedicated edge cluster 1110 is dedicated to the first tenant, meaning that no other tenants can deploy services on this edge cluster 1110. The dedicated edge cluster includes two edge instances 1112 and 1114. While only two edge instances are illustrated for the dedicated edge cluster 1110, one of ordinary skill would understand that a dedicated edge cluster can include any number of edge instances.

Both edge instances 1112-1114 deploy a second logical router 1140 for the first tenant. In this example, a first SR component 1142 is deployed on the first edge instance 1112 and a second SR component 1144 is deployed on the second edge instance 1114. In some embodiments, each SR component 1142-1144 includes one T0 SR component and one T1 SR component. In other embodiments, at least one SR component 1142-1144 includes only one T0 or T1 SR component.

In some embodiments, edge clusters deployed by an SDN environment are orchestrated and managed by an edge orchestrator such that users are not required to provide orchestration and lifecycle management (LCM) of their edge clusters themselves. Service placement and capacity management is managed by a service orchestrator in some of these embodiments.

Edge clusters are in some embodiments deployed without an overlay, and are able to be deployed in private cloud and/or public cloud environments. Additionally, edge clusters in some embodiments deploy and function without any overlay configuration. These edge clusters are available in appropriate formats, such as Open Virtualization Application/Appliance (OVA), Amazon Machine Image (AMI), etc. to be deployed on any IaaS or cloud environment.

In some embodiments, edge clusters also perform appropriate functions to succeed in an underlying IaaS or cloud environment. For example, Address Resolution Protocol (ARP) is not available in an AWS environment, so the edge clusters support encapsulation protocols other than Generic Network Virtualization Encapsulation (Geneve), such as Generic Routing Encapsulation (GRE). These additional encapsulations in some embodiments interoperate with what is used in public cloud environments. Moreover, edge clusters deployed by an SDN in some embodiments provide password-less access.

In some embodiments, an edge orchestrator and service orchestrator cluster creates at least one edge cluster as soon as the system is operational. In such embodiments, instances of the edge cluster are created until (1) a first heterogeneous edge cluster is required by a user, or (2) the edge cluster is referenced in a new T0 logical router defined by the user. When the first heterogeneous edge cluster is required, the orchestrators in some embodiments create a new edge cluster that meets the user's criteria.

When the already created edge cluster is referenced in a new T0 logical router, a new edge cluster needs to be created in some embodiments because each edge cluster is allowed a maximum number of edge instances (e.g., eight edge instances per edge cluster). In such embodiments, when a new T0 logical router is referenced, a new edge cluster is created after the already created edge cluster has its maximum number of edge instances deployed. An edge cluster is in some embodiments system owned, meaning that other users are unable to define transport instances in it.

In some embodiments, a user defines a list of inputs to deploy an edge cluster. In some of these embodiments, the user defines (1) failure domains (e.g., placement criteria, network criteria), (2) other instance settings (e.g., network time protocol (NTP), domain name system (DNS) (e.g., primary and secondary), host names (e.g., created by a management plane per instance)), (3) fast convergence (e.g., edge cluster bidirectional forwarding detection (BFD) timers), (4) passwords (if any), and (5) a compute manager selection (e.g., when more than one private cloud is connected, the user will select which compute manager to use for the edge cluster). In some embodiments, one edge cluster translates to one or more edge appliances, host computers, VMs, etc.

When a user defines which failure domains (or AZs) on which an edge cluster should be deployed, instances of the edge cluster are created in some embodiments on each defined failure domain. With this criteria, the service orchestrator in some embodiments deploys the logical configurations (e.g., services) as HA logical configurations across failure domains. For a private cloud, a user defines the failure domain(s) to deploy an edge cluster. for a public cloud, the user defines the AZs to deploy an edge cluster.

An edge orchestrator in some embodiments is responsible for orchestrating and connecting the edge cluster's VMs. The edge orchestrator is responsible for creating, deleting, and redeploying edge instances by interacting with appropriate IaaS services. The edge orchestrator also in some embodiments connects the NICs and/or IP addresses of the edge instances (e.g., edge VMs, in some embodiments) to an SDN in IaaS. In some embodiments, the edge orchestrator is able to deploy edge clusters in private cloud environments and public cloud environments.

IaaS environments vary in different embodiments and in some embodiments each have their own abstractions to create (i.e., instantiate) and delete (i.e., remove) VMs from the environment. In some embodiments, an edge orchestrator is architected such that newer IaaS environments and clouds can be added incrementally. In some embodiments, the edge orchestrator connects NICs and/or IP addresses of edge VMs to the network in IaaS.

In some embodiments, an edge orchestrator connects edge VMs to the appropriate network. The edge orchestrator in some embodiments is architected with sufficient abstraction to handle different IaaS environments and clouds (e.g., dvPG or equivalent and route table management, security rules in IaaS, etc.) at the time of deployment. An edge orchestrator in some embodiments is also able to detect edge VM failures and can create new edge VMs to replace failed VMs. Edge VMs can also be referred to as edge instances.

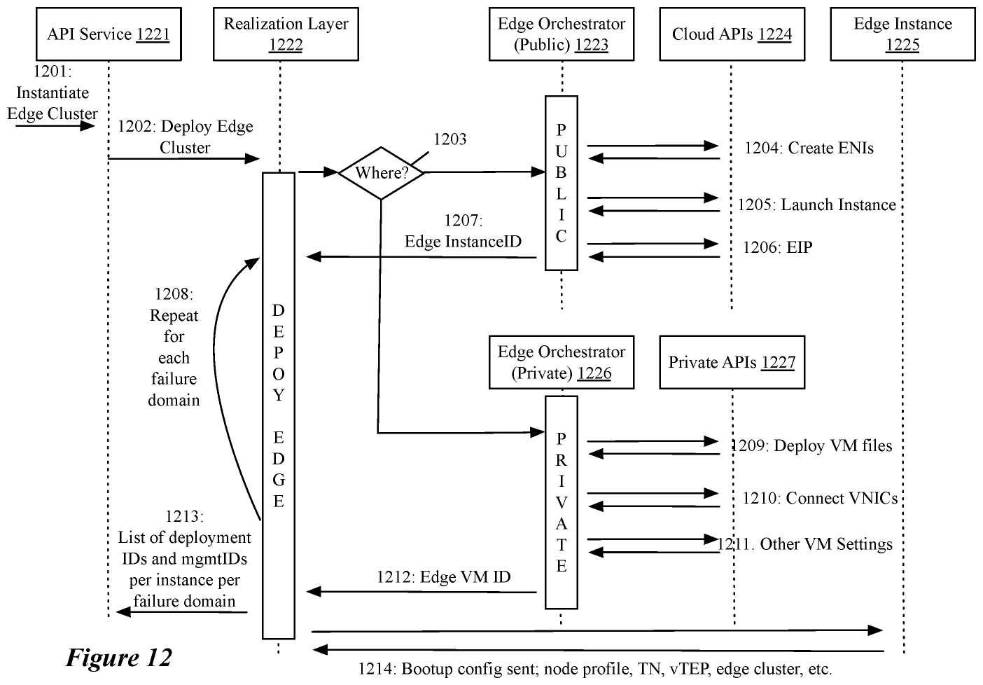

In some embodiments, an edge cluster is deployed by an edge orchestrator that uses an edge object received from a user. FIG. 12 illustrates the communication between an API service 1221, realization layer 1222, public cloud edge orchestrator 1223, cloud APIs 1224, edge instance 1225, private cloud edge orchestrator 1226, and private APIs 1227 for deploying an edge cluster. At 1201, an API service 1221 receives an API for instantiating an edge cluster. This API is received in some embodiments from a user and is received as an edge object the user uses to request deployment of a logical router.

At 1202, the API service 1221 directs the realization layer 1222 to deploy the edge cluster. At 1203, the realization layer 1222 determines whether the edge cluster is to be deployed in a public cloud or a private cloud. In some embodiments, this determination is made based on criteria specified in the API received at 1201.

If the realization layer 1222 determines that the edge cluster is to be deployed in a public cloud, the realization layer 1222 directs the public cloud edge orchestrator 1223 (i.e., a public cloud instance of one edge orchestrator) to use cloud APIs 1224 to create edge network intelligences (ENIs) at 1204, launch at least one instance 1225 of the edge cluster at 1205, and assign the launched instance 1225 an elastic IP address at 1206. At 1207, the public cloud edge orchestrator 1223 provides the launched instance's edge instance ID to the realization layer 1222. Then, at 1208, the realization layer repeats (i.e., goes back to step 1203) for each failure domain defined in the received API.

If the realization layer 1222 determines that the edge cluster is to be deployed in a private cloud, the realization layer 1222 directs the private cloud edge orchestrator 1226 (i.e., a private cloud instance of the edge orchestrator) to use private APIs 1227 to deploy a group of files to deploy a VM for the edge instance 1225 (e.g., Open Vitalization Format (OVF)) at 1209, connect VNICs at 1210, and configure other VM settings at 1211. At 1212, the private cloud edge orchestrator 1226 provides the edge VM ID for the instantiated edge instance 1225 to the realization layer 1222. Then, the realization layer 1222 goes back to step 1208 to repeat (i.e., go back to step 1203) for each failure domain defined in the received API.

After creating all instances of the edge cluster, at 1213, the realization layer 1222 provides a list of deployment IDs and management IDs per instance per failure domain. Then, at 1214, the realization layer 1222 sets up the configuration of the edge instance 1225, creates the instance profile of the edge instance 1225, and configures any host computers (i.e., transport instances), VTEPs, edge clusters, etc.

While different edge orchestrators 1223 and 1226 are illustrated in this figure for deploying the edge cluster in a public cloud versus a private cloud, other embodiments use one edge orchestrator for deploying edge clusters in public and private clouds.

When deploying an edge cluster in a public cloud, the edge orchestrator in some embodiments performs additional steps. In such embodiments, the edge orchestrator configures IP address and/or IP address subnet reachability on VNICs or ENIs to attract traffic to the edge cluster. In some embodiments, it also configures service IP addresses (e.g., NAT, VPN, etc.). Conjunctively or alternatively, the edge orchestrator programs routing and/or security rules in IaaS (e.g., updates route tables to attract/send traffic to the edge cluster).

In some embodiments, the edge orchestrator performs deployment time underlay programming. For runtime failovers, underlay updates are performed by the edge orchestrator in some embodiments using an underlay agent executing on the edge cluster and without any dependency of the SDN's UA or SaaS management layer. For instance, in some embodiments, when IP addresses need to be reassigned from one edge instance NIC to another, IaaS networking is also updated.

A service orchestrator is responsible in some embodiments for placement, availability, and capacity management of logical services implemented on scalable edge clusters. In some embodiments, services are created and associated with an edge object specified by a user. When a new service is created by a user via an edge object, the service orchestrator in some embodiments deploys the service on a set of one or more edge instances and edge clusters deployed for the user. While services are referred to throughout the described embodiments, some embodiments can be implemented for placement of a logical router (and all services within that logical router) before evolving to a more granular service placement over time.

The service orchestrator is in some embodiments an independent microservice or module that executes in the SDN UA or in SaaS. The service orchestrator in some embodiments creates and manages an edge cluster. For instance, each time an edge object is referenced in the creation of a T0 logical router, the service orchestrator in some embodiments creates a new edge cluster. Conjunctively or alternatively, each time a new T0 service router is created or added to a logical router, the service orchestrator in some embodiments directs the edge orchestrator to create a new instance of the edge cluster. In some embodiments, for T1 logical routers under a T0 logical router, the service orchestrator deploys the same edge cluster, or otherwise refers to the capacity management.

In some embodiments, the service orchestrator deploys and/or reallocates logical services on an edge cluster. This is based on at least one of network connectivity, failure domain, and capacity requirements (e.g., edge VM size, CPU allocation, etc.).

When a user creates an edge object (i.e., when the orchestrators receive the logical router criteria), the edge cluster is not immediately instantiated in some embodiments. In such embodiments, the service orchestrator directs the edge orchestrator. For instance, when the edge object is referenced in any services defined by the user and no nodes of the edge cluster are created yet or no created nodes are a match (e.g., for size, for the network in which it is deployed), the service orchestrator directs the edge orchestrator to instantiate one or more edge nodes. As another example, when more nodes of an edge cluster are needed to deploy additional services or scale-out services, the service orchestrator directs the edge orchestrator.

Creating an edge object in some embodiments does not trigger the creation of edge VMs for an edge cluster. In such embodiments, the service orchestrator directs the edge orchestrator to create edge VMs. For example, when an edge object is referenced in any services, but no edge VMs for the edge cluster have been created, there is no existing edge VM that is a good match for placing that service (e.g., for size or network). As another example, when more edge VMs are needed to either scale up (i.e., add additional edge VMs to the edge cluster) or scale out (i.e., add additional resources to edge VMs) the services. In both examples, the service orchestrator hence directs the edge orchestrator to deploy one or more edge VMs.

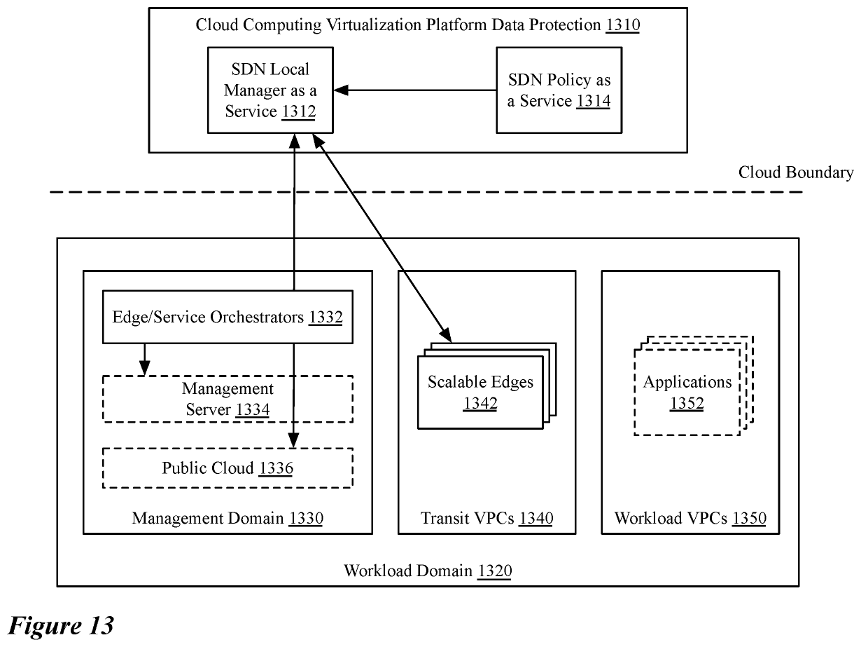

In some embodiments, an edge deployment system includes an edge orchestrator, a service orchestrator, analytics for capacity, and scalable edge operations. This system is implemented in some embodiments in an SDN or in an SaaS environment (e.g., when the SDN does not have a UA, such as perimeter as a service). FIG. 13 illustrates a cloud computing virtualization platform data protection 1310 (e.g., vSphere Data Protection (VDP) offered by VMware, inc.) at one end of a cloud boundary that includes an SDN local Manager as a Service 1312 and an SDN Policy as a Service 1314. At the other side of the cloud boundary, a workload domain 1320 is implemented (e.g., a host computer domain is implemented).

The workload domain 1320 includes a management domain 1330, a set of one or more transit VPCs 1340, and one or more workload VPCs 1350. The management domain 1330 includes a set of edge and service orchestrators 1332, a management server 1334 (e.g., vCenter offered by VMware inc.), and a public cloud 1336 (e.g., AWS, Azure, GCP, etc.). The transit VPCs 1340 include one or more scalable edges 1342. The workload VPCs 1350 include one or more applications 1352. In some embodiments, the SDN Manager as a Service 1312 manages the scalable edges 1342 and the applications 1352.

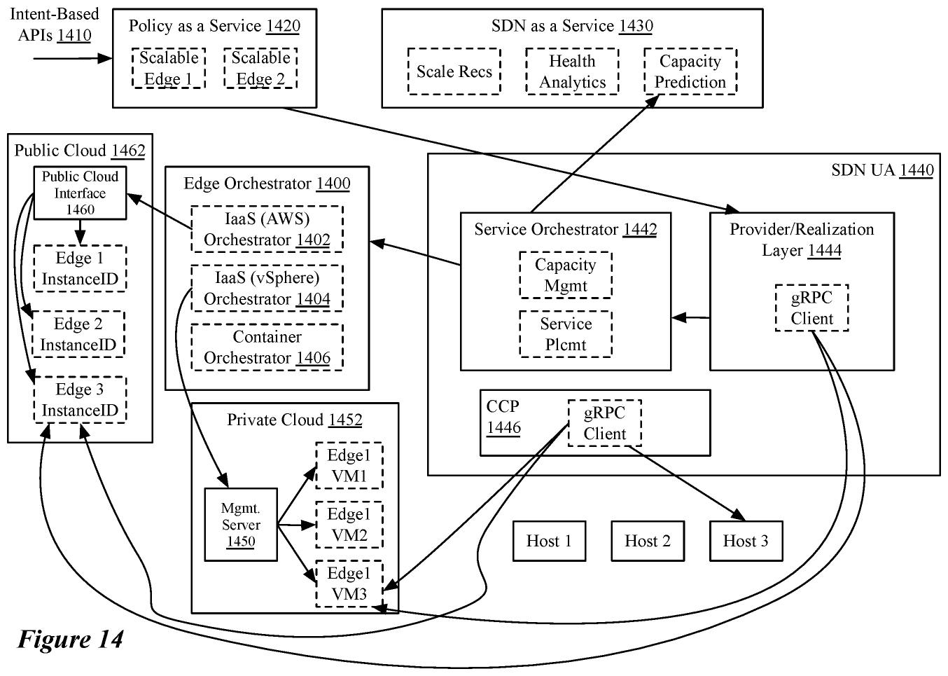

FIG. 14 illustrates an example edge orchestrator 1400 that deploys edge clusters in various cloud environments based on edge objects received from users. In this example, the edge orchestrator 1400 includes three different orchestrators 1402-1406 (e.g., different orchestrator instances) for deploying edges in different cloud environments. A first IaaS orchestrator 1402 executes for deploying edge instances in a public cloud 1462 using a public cloud interface 1460. These edge instances are edges for machines (e.g., VMs, containers, pods) operating on host computers in the public cloud 1462 that are sending data messages outside of the public cloud 1462 through these edges.

A second IaaS orchestrator 1404 executes for deploying edge instances in a private cloud 1452 managed by a management server 1450. These edge instances are edges for machines (e.g., VMs, containers, pods) operating on host computers in the private cloud 1452 that are sending data messages outside of the private cloud 1452 through these edges. A container orchestrator 1406 executes for deploying edge instances on different containers (not shown). In some embodiments, machines execute within the edge instances deployed in the public cloud 1462 and the private cloud 1452 (e.g., to provide services, such as middlebox services).

As intent-based APIs 1410 are sent to a Policy as a Service 1420 (which is a policy parser), the Policy as a Service 1420 parses the intent-based APIs 1410 to identify attributes for two scalable edges. The Policy as a Service 1420 provides the attributes of the scalable edges to a provider/realization layer 1444 of an SDN UA 1440. A service orchestrator 1442 of the SDN UA 1440 provides the attributes to the edge orchestrator 1400.

The service orchestrator 1442 also provides capacity management and service placement (e.g., using capacity management and service placement modules) for the edges deployed by the edge orchestrator 1400. In some embodiments, the service orchestrator 1442 manages capacity predictions of an SDN as a service 1430, which also handles scale recommendations and health analytics for edges. The SDN UA 1440 also includes a CCP 1446, which deploys a remote procedure call (RPC) client, which communicates with one of three hosts, an edge VM deployed at the management server 1450, and an edge instance ID handled by the public cloud 1460.

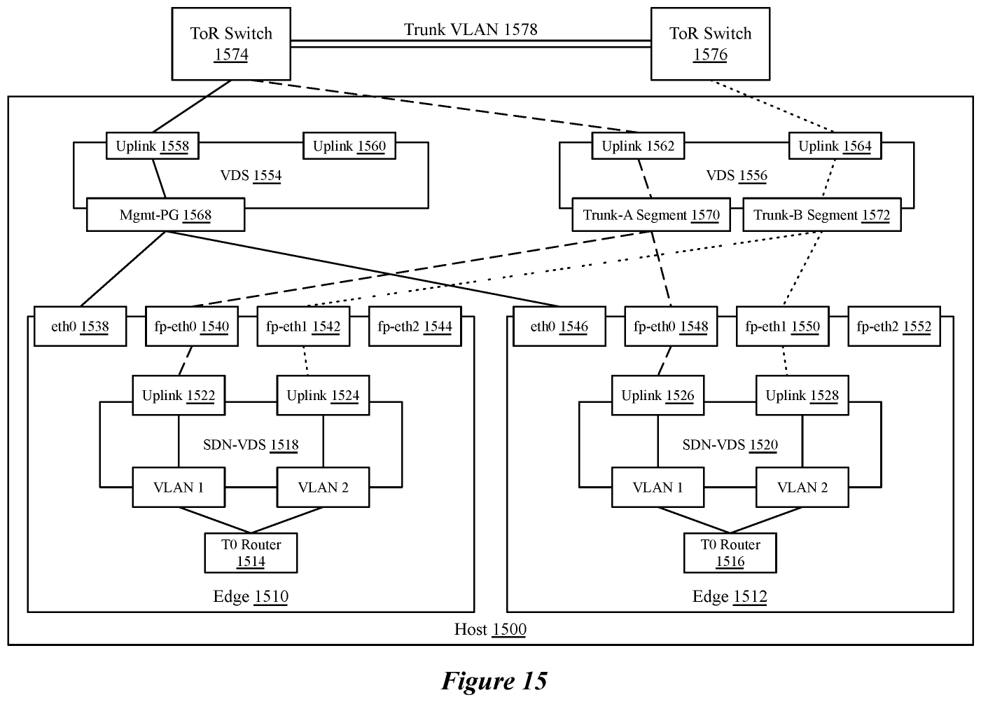

FIG. 15 illustrates a physical representation of a host 1500 and a four-PNIC design for the host 1500. In this example, the host 1500 includes two edge instances 1510-1512 of an edge cluster. The edge instances 1510-1512 include T0 routers 1514-1516 and SDN virtual distributed switches (VDSs) 1518-1520. The SDN VDSs 1518-1520 each include two uplinks 1522-1528, and both are associated with VLANs 1 and 2. Each edge instance 1510-1512 also includes four Ethernet interfaces 1538-1552.

The host 1500 also includes two VDSs 1554-1556. A first VDS 1554 associated with edge instance 1510 includes two uplinks 1558-1560 and a management port group (PG) 1568. A second VDS 1556 includes two uplinks 1562-1564, a Trunk-A segment 1570, and a Trunk-B segment 1572. The host 1500 is associated with two ToR switches 1574-1576 which are connected by a Trunk VLAN 1578. ToR switch 1574 connects to the management PG 1568 of the first edge instance 1510, as denoted by solid lines. ToR switch 1574 connects to VLAN 1 on both edge instances 1510-1512, as denoted by long dashed lines. ToR switch 1576 connects to VLAN 2 on both edge instances 1510-1512, as denoted by short dashed lines.

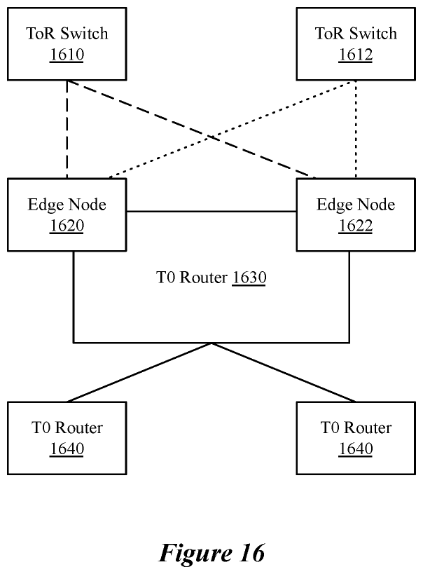

FIG. 16 illustrates a logical representation of ToR switches 1610-1612 connecting to two edge instances 1620-1622. The edge instances 1620-1622 connect to a T0 router 1630, which connects to two T1 routers 1640-1642. ToR switch 1610 connects to VLAN 1 on both edge instances 1620-1622, as denoted by long dashed lines. ToR switch 1612 connects to VLAN 2 on both edge instances 1620-1622, as denoted by short dashed lines.

In some embodiments, if the user of an edge cluster changes the configuration of the edge cluster, all instances of the edge cluster will be adjusted by the edge and service orchestrator. Depending on how the logical configuration is placed on the edge cluster, the management plane in some embodiments disallows the change to the edge cluster configuration. For example, if IP addresses of the IP range used for an edge cluster are assigned to logical router ports, the user will not be able to compress the IP address range.

Elasticity of an edge cluster is disabled in some embodiments. In some of these embodiments, all edge instances of the cluster and all of the services deployed on the edge instances are retained, but the ability for adding new edge instances and new services to the edge cluster is disabled.

As discussed previously, capacity of an edge cluster is in some embodiments managed. For instance, various aspects of an edge cluster are monitored in order to determine when to adjust the edge cluster (e.g., add more edge instances, add additional services, rebalance deployed services, etc.). In such embodiments, the service orchestrator reallocates logical services on an edge cluster to optimize the edge instances' resources. If there is an excess capacity, the service orchestrator in some embodiments consolidates and/or relocates services across the edge instances, and in some embodiments directs the edge orchestrator to remove excess edge instances. In some embodiments, these adjustments to services are independent of the logical router (e.g., when the edge cluster is deployed as containers instead of VMs).

In some embodiments, recommendations regarding adjusting an edge cluster are provided to the edge cluster's user. A capacity score is provided to a user in some embodiments at any particular time (e.g., at any time upon request by the user). In some embodiments, based on capacity scores created for an edge cluster, a time-series view is created to visualize the capacity of the edge cluster over time. This helps the service orchestrator in some embodiments provide recommendations to actions regarding adjusting the edge cluster based on its capacity. In some embodiments, upon selection of a recommended action, the service orchestrator executes the selected recommended actions. In other embodiments, the user manually performs the recommended actions they wish to be performed.

For NIC related metrics, the service orchestrator in some embodiments recommends (1) adding new edge instances or edge clusters, and/or (2) reallocating services. In some embodiments, these metrics are automatically collected by the SDN, and are used in generating a capacity score for an associated edge cluster. For receiving packet misses metrics (e.g., when edge ring buffers are exhausted), the service orchestrator in some embodiments defines a threshold (e.g., 2% of total receiving packets can be missed), and will send an alarm notification to the user after a particular time (e.g., 120 seconds) the threshold has been met or has been exceeded.

For throughput metrics, the service orchestrator in some embodiments defines a threshold (e.g., 80%), and sends an alarm notification to the user when the throughput is measured to be at or above the threshold for a particular period of time (e.g., 180 seconds). In some embodiments, the throughput of an edge cluster depends on the hardware on which is id deployed. For transmitting packet drop metrics (e.g., when an edge cluster or an edge instance is having resource or ring buffer issues), the service orchestrator recommends identifying a less busy host and migrating the edge instance (i.e., the VM the edge instance is deployed as) to the identified host. In some of these embodiments, when migrating an edge instance, the service orchestrator put the edge instance into failover mode before migrating it to the destination host.

To add additional CPU to an edge cluster, the service orchestrator in some embodiments recommends (1) adding additional edge instances to the edge cluster, and/or (2) enabling dynamic core allocation. For data plane core usage metrics, the service orchestrator in some embodiments defines a threshold (e.g., 80%), and sends an alarm notification to the user when the data plane core usage is measured to be at or above the threshold for a particular period of time (e.g., 120 seconds).

For service core usage metrics, the service orchestrator in some embodiments defines a threshold (e.g., 60%), and sends an alarm notification to the user when the service core usage is measured to be at or above the threshold for a particular period of time (e.g., 120 seconds). To add additional memory to an edge cluster, the service orchestrator in some embodiments recommends adding additional edge instances to an edge cluster.

For system memory metrics, the service orchestrator in some embodiments defines a threshold (e.g., 80%), and sends an alarm notification to the user when the throughput is measured to be at or above the threshold for a particular period of time (e.g., 120 seconds). For data plane memory pool metrics, the service orchestrator in some embodiments defines a threshold (e.g., 85), and sends an alarm notification to the user when the system memory is measured to be at or above the threshold for a particular period of time (e.g., 240 seconds). To increase the maximum configuration for an edge cluster, the service orchestrator in some embodiments recommends (1) adding additional edge instances or additional edge clusters, and/or (2) reallocating services.

In some embodiments, L3-L7 services are offered on a logical router and cannot scale independently of the logical router. In other embodiments, they are able to be scaled independently. In such embodiments, inputs from a user are translated to edge VM instance size, core allocation, etc.

The service orchestrator in some embodiments provides default profiles, which map to medium and large edge instances, which will be described further below. If a user does not specify a capacity profile in the configuration of a logical router port, the service orchestrator default to using the one mapping to medium edges.

In some embodiments, the user is asked to select services, which are then translated to determine the edge VM size. In some embodiments, a set of one or more service types need more resources than other services, such as VPN and L7 firewall with IDS services. The user is also asked in some embodiments to specify their desired throughput, which is then translated to determine the edge VM size.

When a user creates a logical router, the user in some embodiments specifies an edge cluster ID.

In some embodiments, an interface group, which is a group of external interfaces, is created for redundancy on different edge instances (i.e., different service routers implemented on the different edge instances) meant to reach the same external connectivity. An interface group is exposed in some embodiments as an active/active construct. In other embodiments, it is exposed as an active/standby construct.

When creating a logical router, the user in some embodiments creates the segments and logical router ports simultaneously. When the user creates NAT and/or firewall rules on an interface group, the service orchestrator in some embodiments realizes them on the external interfaces and the logical router ports.

In some embodiments, a user specifies an edge path, a capacity profile ID, a segment path, and a set of one or more subnets (e.g., one per failure domain). For enhanced realization APIs, the external interfaces, uplink logical router ports, and edge cluster instances when they are deployed are shown internally. If the edge cluster has multiple failure domains, but the defined interface group does not have inputs for all failure domains, the service orchestrator sends an alarm notification to the user to reflect that the redundant uplink logical router ports are missing.

The service and edge orchestrators in some embodiments support multiple next-hops for a given network, which can take traffic out from different service routers in different failure domains. When service routers are automatically scaled by the service and edge orchestrators, a border gateway protocol (BGP) is in some embodiments scaled simultaneously. If not, north-south benefits are lost. When scaling BGP, a peer is in some embodiments added automatically on the SDN side. New service routers (i.e., T0 routers) in some embodiments initiate BGP connections. In some embodiments, ToR switches accept the peers from a subnet range. Dynamic BGP peering is supported by ToR switches in some embodiments (e.g., ToR switches provided by Cisco, Arista, Cumulus, etc.).

In some embodiments, a NAT rule or a firewall rule specifies its “AppliedTo” field as an interface group. In some of these embodiments, if the system has created multiple service routers and uplink logical router ports based the defined failure domain configuration, the NAT or firewall rule is applied to all of the logical router ports (e.g., using the label the service/edge orchestrator created for those uplinks).

To create NAT rules, the user in some embodiments is allowed to defined public IP addresses, e.g., using an IP address pool ID. In some embodiments, this IP pool ID is the same as given in the elastic edge network configuration, if the user wishes to use the same subnet. In some embodiments, public IP addresses for NAT rules for all failure domains are in the same subnet.

In some embodiments, each edge instance (i.e., each edge VM) is individually monitored. In such embodiments, all instantiated edge instances of an edge cluster are monitored to determine which logical routers and services to deploy on each edge instance. In some embodiments, monitoring data is sent to a Policy as a Service in an SDN. The receiver of this monitoring data is in some embodiments multi-tenant aware. In some embodiments, a secure hash algorithm (SHA) ingests metrics to a secure data collection platform cluster using RPC (e.g., gRPC). From here, analyzing of the metrics is performed in some embodiments and sent to an SDN application platform (e.g., NAX Application Platform (NAAP) offered by VMware, inc.). In some embodiments, events and alarms are configured to operate in Policy as a Service.

Alarms in some embodiments (1) identify erroneous edge instances and initiates evacuation and remediations, (2) are sent when scaling of an edge cluster is finished, and/or (3) are sent when services need to be reallocated in an edge cluster.

An SHA plugin is implemented in some embodiments to collect metrics. In some embodiments, realization APIs identify which service is deployed on which edge instance of an edge cluster.

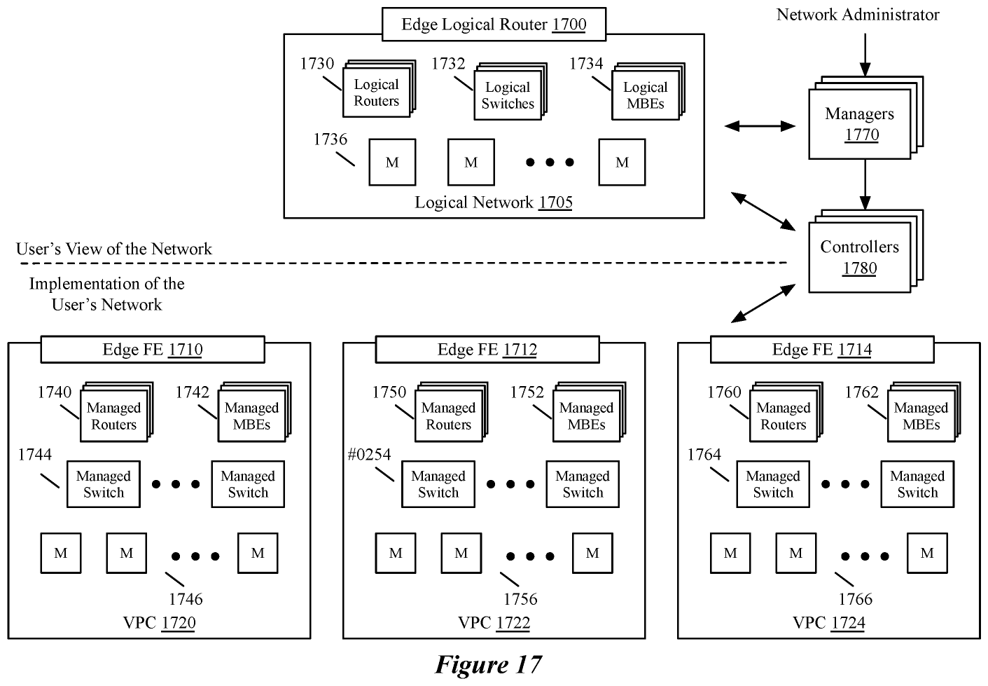

As discussed previously, a logical router is implemented as a set of one or more instances in a set of one or more clouds. FIG. 17 illustrates an example edge logical router 1700 of a network administrator's logical network 1705 implemented as a set of edge forwarding elements (FEs) 1710-1714 in a set of VPCs 1720-1724. The edge logical router 1700 can also be referred to as a logical edge gateway. These edge FEs 1710-1714 are edge instances of an edge cluster implemented to represent the edge logical router 1700. The network administrator views the implemented set of edge FEs 1710-1714 implemented in the different VPCs 1720-1724 as the edge logical router 1700 executing in the logical network 1705. The logical network 1705 also includes other network elements, such as logical routers 1730, logical switches 1732, logical middlebox elements 1734, and machines 1736.

The edge logical router 1700 operates at the edge of the logical network 1705 to provide edge services (e.g., forwarding) to data message flows entering and exiting the logical network (i.e., north-south traffic) and to data message flows exchanged within the logical network (i.e., east-west traffic). The edge logical router 1700 is deployed in the VPCs 1720-1724 as the cluster of edge FEs 1710-1714.

The logical network 1705 and its components (i.e., the edge logical router 1700, routers 1730, switches 1732, middlebox elements 1734, and machines 1736) are implemented within these three VPCs 1720-1724, (i.e., each component of the logical network 1705 is mapped to the VPCs 1720-1724). In some embodiments, the VPCs 1720-1724 are segregated networks of one cloud (e.g., of one public cloud, of one private cloud). In other embodiments, the VPCs 1720-1724 are segregated networks of at least two clouds (e.g., of at least two public clouds, of at least two private clouds, of a combination of public and private clouds).

A first VPC 1720 implementing a first edge FE 1710 also includes a set of one or more managed routers 1740, a set of one or more managed middlebox elements 1742, one or more managed switches 1744, and one or more machines 1746. A second VPC 1722 implementing a second edge FE 1712 also includes a set of one or more managed routers 1750, a set of one or more managed middlebox elements 1752, one or more managed switches 1754, and one or more machines 1756. A third VPC 1724 implementing a third edge FE 1714 also includes a set of one or more managed routers 1760, a set of one or more managed middlebox elements 1762, one or more managed switches 1764, and one or more machines 1766.

The sets of managed routers 1740, 1750, and 1760 are physical routers that implement the logical routers 1730 of the logical network 1705. The sets of managed middlebox elements 1742, 1752, and 1762 are physical middlebox service machines that implement the logical middlebox elements 1734 of the logical network 1705. The sets of managed switches 1744, 1754, and 1764 are physical switches that implement the logical switches 1732 of the logical network 1705. The sets of machines 1746, 1756, and 1766 are physical machines implement the machines 1736 (e.g., VMs, containers, pods) of the logical network 1705. In some embodiments, an edge FE of an VPC performs the middlebox services for that VPC. For example, the edge FE 1710 in some embodiments performs the middlebox services 1742 for the VPC 1720.

In some embodiments, the VPCs 1720-1724 are segregated networks of one cloud (e.g., of one public cloud, of one private cloud). In other embodiments, the VPCs 1720-1724 are segregated networks of at least two clouds (e.g., of at least two public clouds, of at least two private clouds, of a combination of public and private clouds).

In some embodiments, a set of managers 1770 implemented by one or more management servers manages the edge logical router 1700. The manager set 1770 interacts with the network administrator (e.g., through a UI, a GUI, etc. using Application Programming Interface (API) calls) to deploy the logical network 1705 and its logical components in the VPCs 1720-1724. A set of one or more controllers 1780 in such embodiments configures and manages the edge cluster by direction of the manager set 1770. The manager set 1770 creates the user's view of the network (i.e., the logical network 1705) and communicates with the controller set 1780 to implement the user's view of the network and configure the edge FEs 1710-1714 and the VPCs 1720-1724. The manager set 1770 in some embodiments implements a management plane, and the controller set in such embodiments implements a control plane.

Deploying the logical router 1700 of the logical network 1705 as a set of edge FEs 1710-1714 (i.e., as edge instances of an edge cluster) allows the network administrator of the logical network 1705 to request deployment of the logical router 1700 using a template of criteria (such as the user-defined criteria 110 of FIG. 1). This template is converted into an edge object, which is used (e.g., by edge and service orchestrators, by the managers 1770 and controllers 1780) to deploy the edge FEs 1710-1714 in the VPCs 1720-1724. Then, monitoring of the edge FEs 1710-1714 enables automatic creation of new edge FEs in the VPCs 1720-1724 to implement the logical router 1700 and automatic creation of new edge FEs in new VPCs to expand the span of the edge FEs implementing the logical router 1700.

Each edge instance 1710-1714 typically handles north-south traffic through its respective VPC, as the edge logical router 1700 would handle north-south traffic between the network administrator's logical network 1705 and one or more external networks. In addition, each VPC's edge FE in some embodiments handles east-west traffic within its VPC. For example, when a VPC has multiple network segments (e.g., separate logical L2 segments), the edge FE of that VPC handles the east-west traffic between these network segments. This edge FE can be used to send a data message from a first machine connected to a first L2 segment (e.g., a first logical switch) to a second machine connected to a second L2 segment (e.g., a second logical switch) by receiving the data message from the first machine and forwarding it to the second machine.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

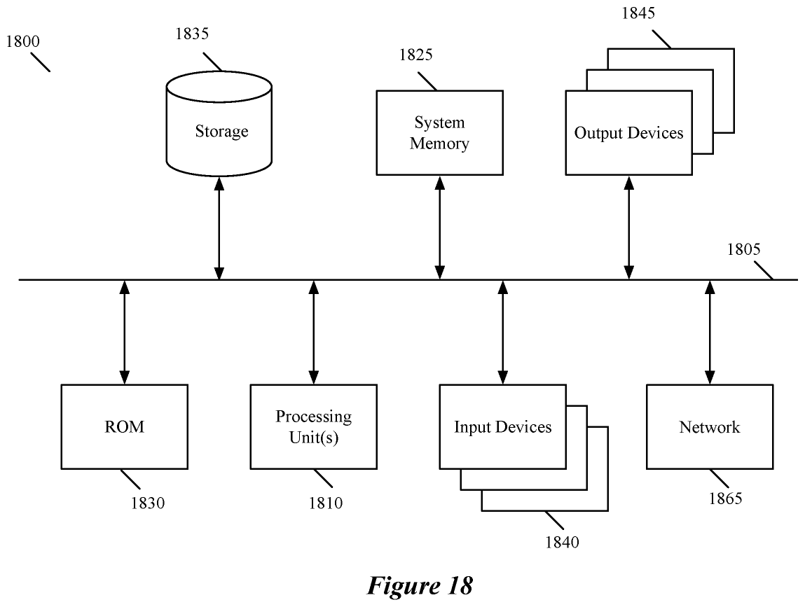

FIG. 18 conceptually illustrates a computer system 1800 with which some embodiments of the invention are implemented. The computer system 1800 can be used to implement any of the above-described computers and servers. As such, it can be used to execute any of the above described processes. This computer system includes various types of non-transitory machine readable media and interfaces for various other types of machine readable media. Computer system 1800 includes a bus 1805, processing unit(s) 1810, a system memory 1825, a read-only memory 1830, a permanent storage device 1835, input devices 1840, and output devices 1845.

The bus 1805 collectively represents all system, peripheral, and chipset buses that communicatively connect the numerous internal devices of the computer system 1800. For instance, the bus 1805 communicatively connects the processing unit(s) 1810 with the read-only memory 1830, the system memory 1825, and the permanent storage device 1835.

From these various memory units, the processing unit(s) 1810 retrieve instructions to execute and data to process in order to execute the processes of the invention. The processing unit(s) may be a single processor or a multi-core processor in different embodiments. The read-only-memory (ROM) 1830 stores static data and instructions that are needed by the processing unit(s) 1810 and other modules of the computer system. The permanent storage device 1835, on the other hand, is a read-and-write memory device. This device is a non-volatile memory unit that stores instructions and data even when the computer system 1800 is off. Some embodiments of the invention use a mass-storage device (such as a magnetic or optical disk and its corresponding disk drive) as the permanent storage device 1835.

Other embodiments use a removable storage device (such as a flash drive, etc.) as the permanent storage device. Like the permanent storage device 1835, the system memory 1825 is a read-and-write memory device. However, unlike storage device 1835, the system memory is a volatile read-and-write memory, such a random access memory. The system memory stores some of the instructions and data that the processor needs at runtime. In some embodiments, the invention's processes are stored in the system memory 1825, the permanent storage device 1835, and/or the read-only memory 1830. From these various memory units, the processing unit(s) 1810 retrieve instructions to execute and data to process in order to execute the processes of some embodiments.

The bus 1805 also connects to the input and output devices 1840 and 1845. The input devices enable the user to communicate information and select commands to the computer system. The input devices 1840 include alphanumeric keyboards and pointing devices (also called “cursor control devices”). The output devices 1845 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 18, bus 1805 also couples computer system 1800 to a network 1865 through a network adapter (not shown). In this manner, the computer can be a part of a network of computers (such as a local area network (“LAN”), a wide area network (“WAN”), or an Intranet, or a network of networks, such as the Internet. Any or all components of computer system 1800 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. In addition, a number of the figures (including FIGS. 2, 4, and 12) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

1. A method for configuring components of a software-defined network (SDN) to automatically deploy and monitor a logical edge router for a user, the method comprising:
configuring a policy parser to parse an intent-based Application Programming Interface (API) request to identify a set of attributes for the logical edge router; and
configuring a set of multi-cloud edge orchestrators (i) to use the set of attributes to derive an edge deployment plan specifying a set of two or more edge instances to implement the logical edge router, and (ii) to deploy the set of edge instances in a set of two or more clouds based on the edge deployment plan, wherein the edge deployment plan specifies a set of two or more edge instances implemented using physical and virtual network elements, a resource allocation and a scaling of the edge instances based on network performance metrics.

2. The method of claim 1, wherein the policy parser is configured to receive the intent-based API request to parse and identify the set of attributes for the logical edge router.

3. The method of claim 1, wherein the set of attributes is a first set of attributes and configuring the edge orchestrator to use the first set of attributes to derive the edge deployment plan comprises configuring the edge orchestrator (i) to define an edge object based on the first set of attributes for the logical edge router and (ii) to analyze a second set of attributes of the edge object to derive the edge deployment plan.

4. The method of claim 3, wherein:
the first set of attributes is in a first format readable by the user,
the second set of attributes is in a second format readable by the edge orchestrator, and
the edge orchestrator defines the edge object by translating the first set of attributes into the second set of attributes.

5. The method of claim 4, wherein the edge orchestrator analyzes the second set of attributes to derive the edge deployment plan by analyzing the second set of attributes to determine, for the edge deployment plan, (i) a particular number of edge instances to include in the set of edge instances, (ii) a particular edge instance size for each edge instance, (iii) a particular amount of central processing unit (CPU) to allocate to each edge instance, (iv) a particular amount of memory to allocate to each edge instance, and (v) a particular location to deploy each edge instance.

6. The method of claim 1, wherein the set of multi-cloud edge orchestrators comprises a public cloud edge orchestrator and a private cloud edge orchestrator.

7. The method of claim 6, wherein configuring the set of multi-cloud edge orchestrators to deploy the set of edge instances in the set of clouds comprises configuring the public cloud edge orchestrator to deploy the set of edge instances in a set of two or more public clouds.

8. The method of claim 6, wherein configuring the set of multi-cloud edge orchestrators to deploy the set of edge instances in the set of clouds comprises configuring the private cloud edge orchestrator to deploy the set of edge instances in a set of two or more private clouds.

9. The method of claim 6, wherein configuring the set of multi-cloud edge orchestrators to deploy the set of edge instances in the set of clouds comprises:
configuring the public cloud edge orchestrator to deploy a first subset of the set of edge instances in a set of one or more public clouds; and
configuring the private cloud edge orchestrator to deploy a second subset of the set of edge instances in a set of one or more private clouds.

10. The method of claim 1 further comprising configuring a service orchestrator to collect metrics associated with each edge instance and analyze the collected metrics to perform capacity management and service placement for the logical edge router.

11. The method of claim 10, wherein the service orchestrator is part of an SDN realization layer.

12. The method of claim 11, wherein the service orchestrator is configured to receive the set of attributes from the policy parser to provide to the edge orchestrator after determining that the logical edge router has not yet been deployed.

13. The method of claim 10, wherein configuring the service orchestrator comprises configuring the service orchestrator with (i) a capacity management module to monitor capacity of each of the set of edge instances based on the collected metrics and (ii) a service placement module deploy services on one or more of the set of edge instances based on the collected metrics.

14. The method of claim 13, wherein the service placement module is configured to collect a first set of metrics before deployment of the set of edge instances that implement the logical edge router, and the capacity management module is configured to collect a second set of metrics after deployment of the set of edge instances to modify the edge deployment plan and the deployment of the set of edge instances.

15. The method of claim 14, wherein the service placement module is configured to collect the first set of metrics associated with each edge instance in the set of edge instances and analyze the collected metrics to determine which edge instance should perform each services.

16. The method of claim 15, wherein the services comprise one or more of routing, firewall services, load balancing services, network address translation (NAT) services, intrusion detection system (IDS) services, intrusion prevention system (IPS) services, virtual private network (VPN) services, and virtual tunnel endpoint (VTEP) services for data message flows traversing the set of edge instances to implement the logical edge router.

17. The method of claim 14, wherein the second set of metrics comprise at least one of central processing unit (CPU) metrics associated with each edge instance and memory metrics associated with each edge instance.

18. The method of claim 17, wherein the capacity management module is configured to:
analyze the second set of metrics to determine that a particular CPU usage of a particular edge instance has exceeded a particular threshold;
modify the edge deployment plan to specify at least one additional edge instance to alleviate load on the particular edge instance; and
provide the modified edge deployment plan to the edge orchestrator.

19. The method of claim 18, wherein the edge orchestrator is configured to:
receive the modified edge deployment plan from the capacity management module; and
deploy the at least one additional edge instance to implement the logical edge router.

20. A non-transitory machine readable medium storing a program for execution by at least one processing unit for configuring components of a software-defined network (SDN) to automatically deploy and monitor a logical edge router for a user, the program comprising sets of instructions for:
configuring a policy parser to parse an intent-based Application Programming Interface (API) request to identify a set of attributes for the logical edge router; and
configuring a set of multi-cloud edge orchestrators (i) to use the set of attributes to derive an edge deployment plan specifying a set of two or more edge instances to implement the logical edge router, and (ii) to deploy the set of edge instances in a set of two or more clouds based on the edge deployment plan, wherein the edge deployment plan specifies a set of two or more edge instances implemented using physical and virtual network elements, a resource allocation and a scaling of the edge instances based on network performance metrics.
